(19) United States
(12) Patent Application Publication
(10) Pub. No.: US 2006/0285461 A1
(43) Pub. Date: Dec. 21, 2006

(54) Evaluation apparatus, evaluation method, and optical disk manufacturing method

(75) Inventors: Koji Ashizaki, Tokyo (JP); Goro Fujita, Kanagawa (JP); Seiji Kobayashi, Kanagawa (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/446,869

(22) Filed: Jun. 5, 2006

(30) Foreign Application Priority Data
Jun. 10, 2005 (JP) JP2005-171645

(51) Int. Cl. G11B 20/18

(52) U.S. Cl. 369/53.16

(57) ABSTRACT

An evaluation apparatus for evaluating the recording quality of secondary data recorded on an optical disk recording medium on which primary data is recorded as combinations of pits and lands includes the following elements: a reading unit operable to read a signal on the basis of reflected light information of a laser beam of playback power irradiated onto the optical disk recording medium; a binarizing unit operable to slice the signal read by the reading unit at a predetermined level and output the result as a binary signal; and a jitter calculating unit operable to calculate a jitter of edge shift amounts on the basis of a standard deviation and an average of the edge shift amounts and information on a predetermined minimum shift amount determined as the minimum amount of shift that can be detected by a binary decision as an edge shift.

### CROSS REFERENCES TO RELATED APPLICATIONS

The present invention contains subject matter related to Japanese Patent Application JP 2005-171645 filed in the Japanese Patent Office on Jun. 10, 2005, the entire contents of which are incorporated herein by reference.

### BACKGROUND OF THE INVENTION

1. Field of the Invention

The present invention relates to an evaluation apparatus and an evaluation method for evaluating the recording quality of secondary data recorded on an optical disk recording medium on which primary data different from the secondary data is recorded as combinations of pits and lands, the secondary data being recorded by inducing edge shifts by irradiating edge portions of pits and lands formed at a plurality of positions with a laser beam of predetermined recording power.

The present invention also relates to an optical disk manufacturing method for manufacturing the above-described optical disk recording medium by recording the secondary data on the basis of the evaluation result obtained by the evaluation apparatus.

2. Description of the Related Art

Optical disks, especially playback-only ROM disks, are widely used as package media all over the world since replica substrates can be mass-produced in a short period of time by plastic injection molding using a stamper. For example, compact discs (CDs) and digital versatile discs (DVDs) are widely and commonly used as ROM disks for recording information such as music and video.

So-called pirated disks have been produced by illegally copying recorded data based on ROM disks sold as such package media, and copyright infringement has been a problem.

Various techniques for preventing the manufacture of pirated disks have been proposed. One of these techniques is known as, for example, additionally recording identification information different for each disk. By additionally recording identification information different for each disk, a system in which a playback apparatus reads the identification information and transmits the identification information via a network to an external server can be configured. With the use of such a system, when, for example, pirated disks are produced and sold, the server detects many pieces of the same identification information, thereby detecting the presence of the pirated disks. By locating the playback apparatus having sent the detected identification information, it is possible to locate the pirated disk manufacturer.

A known technique for additionally recording the identification information on ROM disks involves providing an additional recording area, such as a burst cutting area (BCA), for the identification information in an area other than that in which recording is performed as pits and lands on the disk.

However, when recording is performed in an area other than that in which recording is performed as pits and lands, it is difficult to apply a tracking servo during the reading/writing of the identification information. At the time of recording, it is necessary to form a recording mark with a relatively large width.

As is commonly known, the identification information is written in the BCA by burning out a reflecting layer. Since, as described above, it is necessary to form the recording mark with a large width, it is necessary to irradiate the disk with a laser beam for a relatively long period of time. It is thus difficult to efficiently record the identification information.

In particular, the recording of identification information for copyright protection is sequentially performed on mass-produced ROM disks. When the recording is not performed efficiently, delivery of the ROM disks may be behind schedule.

A technique for additionally recording identification information on a ROM disk is proposed as, for example, “Postscribed ID™” (trademark of Sony Corporation) (for example, see URL: http;//postscribed.com/index_jam, searched on May 6, 2005).

Postscribed ID™ is a technique that determines in advance, in an area where recording is performed as pits and lands on a disk, an area for writing identification information and records predetermined pattern data for forming edge portions between pits and lands in this area.

Then, the identification information is recorded by irradiating/not irradiating the edge portions with a high-output recording laser beam, thereby inducing/not inducing edge shifts. In other words, the disk is provided with a plurality of areas in which the above-described predetermined pattern data is recorded. An edge shift is induced in one area, whereas no edge shift is induced in another area, thereby recording the identification information “0” and “1”.

The playback apparatus plays back each of the predetermined areas on the disk. When the played back data in an area is the same as the predetermined pattern data, it is determined that the value “0” is recorded. When the played back data differs from the predetermined pattern data, it is determined that the value “1” is recorded.

According to the above-described recording technique, identification information can be additionally recorded in an area in which data is recorded as pits and lands by shifting edge portions between the pits and lands. Therefore, the recording mark itself can be greatly reduced in size, compared with the case of BCA, and the irradiation time of a laser beam for recording can also be greatly reduced. That is, the time for additionally recording the identification information can be reduced.

### SUMMARY OF THE INVENTION

In order to stabilize the recording of identification information, it is desirable to evaluate, in the case where identification information is additionally recorded by shifting edge portions between pits and lands on a ROM disk, a signal recorded by inducing the edge shifts and to adjust parameters including, for example, laser power on the basis of the evaluation result, thereby optimizing the recording.

The present inventors have recognized, however, that no technique has been proposed thus far for appropriately evaluating information additionally recorded by inducing such edge shifts.

According to an embodiment of the present invention, there is provided an evaluation apparatus for evaluating the recording quality of secondary data recorded on an optical disk recording medium on which primary data different from the secondary data is recorded as combinations of pits and lands, the secondary data being recorded by inducing edge shifts by irradiating edge portions between pits and lands formed at a plurality of positions with a laser beam of predetermined recording power. The evaluation apparatus includes the following elements: reading means for reading a signal on the basis of reflected light information of a laser beam of playback power irradiated onto the optical disk recording medium; binarizing means for slicing the signal read by the reading means at a predetermined level and outputting the result as a binary signal; and jitter calculating means for calculating a jitter of edge shift amounts in portions, among the edge portions between the pits and the lands formed at the plurality of positions, in which the edge shifts are induced, the edge shift amounts being measured on the basis of the binary signal obtained by the binarizing means, the jitter being calculated on the basis of a standard deviation and an average of the edge shift amounts and information on a predetermined minimum shift amount determined as the minimum amount of shift that can be detected by a binary decision as an edge shift.

According to the aforementioned evaluation apparatus, as has been done for optical disk recording media, a jitter representing fluctuation in the time domain for a distribution of edge shift amounts in edge portions between pits and lands is calculated on the basis of a standard deviation and an average of the edge shift amounts.

According to the aforementioned evaluation apparatus, however, a jitter is calculated not for primary data recorded as combinations of pits and lands, but is calculated for secondary data recorded by inducing edge shifts. It is thus difficult to calculate an accurate evaluation index simply on the basis of the standard deviation and the average of the distribution of edge shift amounts.

This can be understood by examining the secondary data playback operation. Specifically, a playback apparatus determines whether an edge shift has been induced on the basis of a result of a binary decision for a signal read from the optical disk recording medium. That is, an edge shift amount is detected in units of 1 T (channel bit). In order to detect an edge shift at the time of playback, it is necessary for the shift amount to be greater than or equal to the minimum shift amount (e.g., 0.5 T) that can be detected as a shift amount of 1 T.

In contrast, in the case in which, as in jitter calculation for primary data, which has been done in the past, a jitter is calculated by dividing the standard deviation of the distribution of shift amounts simply on the basis of the average of the distribution, a reference range for calculating the jitter includes a range from the original edge portion (i.e., the position at which the shift amount is zero). In other words, when the known jitter calculation is simply applied, a range less than or equal to the minimum shift amount is included in the jitter calculation area. Supposing to obtain, as in the embodiment of the present invention, an evaluation value for the recording quality of secondary data recorded by inducing edge shifts, it is difficult to obtain an accurate evaluation value.

Therefore, as in the embodiment of the present invention, a jitter is calculated on the basis of the standard deviation and the average of the distribution of edge shift amounts and information on the minimum shift amount, thereby calculating an accurate jitter on the basis of only a range in which an edge shift is detectable by a binary decision made by the playback apparatus.

According to the embodiment of the present invention, there is provided an evaluation index for appropriately evaluating the recording quality of secondary data recorded on an optical disk recording medium on which primary data different from the secondary data is recorded as combinations of pits and lands, the secondary data being recorded by inducing edge shifts in edge portions between pits and lands formed at a plurality of positions.

### BRIEF DESCRIPTION OF THE DRAWINGS

FIG. 1 is a cross-sectional view of an optical disk recording medium (primary data recording disk) for use in an embodiment of the present invention;

FIG. 2 is a data structure diagram illustrating the data structure of data recorded on the optical disk recording medium shown in FIG. 1;

FIG. 3 is a data structure diagram illustrating the data structure within a frame of the data recorded on the optical disk recording medium;

FIG. 4 is a diagram illustrating a recording method of the embodiment;

FIG. 5 is a diagram showing the appearance of the disk when an edge shift is induced by making a land into a pit, recording waveforms subsequent to the edge shift, and the values of modulation bits and data bits obtained as a result thereof;

FIG. 6 is a diagram showing the appearance of the disk when an edge shift is induced by making a pit into a land, recording waveforms subsequent to the edge shift, and the values of modulation bits and data bits obtained as a result thereof;

FIG. 7 is a diagram showing all possible modes of edge shifts in the case where the recording method according to the embodiment is employed;

FIG. 8 is a block diagram showing the internal configuration of a recording apparatus for implementing the recording method according to the embodiment;

FIG. 9 is a data structure diagram showing data content to be stored in the recording apparatus;

FIG. 10 is a flowchart showing an operation to be performed by the recording apparatus to implement the recording method according to the embodiment;

FIG. 11 is a schematic diagram showing fluctuation in shift amounts in each type of edge-shifted portion;

FIG. 12 is a diagram illustrating the concept of jitter in the embodiment;

FIG. 13 is a block diagram showing the internal configuration of an evaluation apparatus according to the embodiment;

FIG. 14 is a chart illustrating an evaluation value measuring operation according to the embodiment;

FIG. 15 is a flowchart showing an operation to be performed by the evaluation apparatus to implement the evaluation value measuring operation according to the embodiment;

FIG. 16 is a diagram illustrating a method for manufacturing the optical disk recording medium using the evaluation apparatus of the embodiment;

FIG. 17 is a diagram illustrating a recording method according to a first modification;

FIG. 18 is a diagram showing the appearance of the disk when an edge shift is induced by making a land into a pit, recording waveforms subsequent to the edge shift, and the values of modulation bits and data bits obtained as a result thereof according to the first modification;

FIG. 19 is a diagram showing the appearance of the disk when an edge shift is induced by making a pit into a land, recording waveforms subsequent to the edge shift, and the values of modulation bits and data bits obtained as a result thereof according to the first modification;

FIG. 20 is a diagram showing all possible modes of edge shifts in the case where the recording method according to the first modification is employed;

FIG. 21 is a diagram illustrating a recording method according to a second modification;

FIG. 22 is a diagram showing the appearance of the disk when an edge shift is induced by making a land into a pit, recording waveforms subsequent to the edge shift, and the values of modulation bits and data bits obtained as a result thereof according to the first modification; and

FIG. 23 is a schematic diagram showing fluctuation in shift amounts in each type of edge-shifted portion in the case where the recording method according to the second modification is employed.

### DESCRIPTION OF THE PREFERRED EMBODIMENTS

Preferred embodiments of the present invention (hereinafter referred to as embodiments) will be described below in the following order:

1. Optical disk recording medium

2. Recording method

3. Recording apparatus

4. Secondary data evaluation value

5. Evaluation apparatus

6. Evaluation value measuring operation

7. Optical disk manufacturing method using evaluation apparatus

8. Modifications

1. Optical Disk Recording Medium

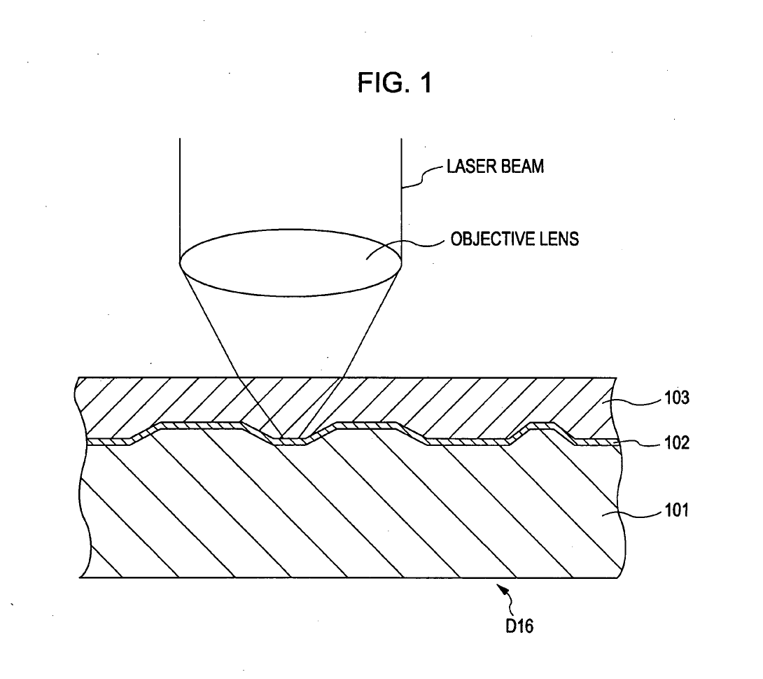

FIG. 1 is a cross-sectional view of an optical disk recording medium (primary data recording disk D16) for use in an embodiment of the present invention.

The primary data recording disk D16 for use in the embodiment is a playback-only ROM disk. Specifically, the primary data recording disk D16 conforms to the disk structure and format of discs referred to as “Blu-Ray Discs”.

The disk D16 includes, as shown in FIG. 1, a substrate 101, a reflecting layer 102 laminated on the substrate 101, and a covering layer 103 attached to the reflecting layer 102. The surface of the substrate 101 in contact with the reflecting layer 102 has an uneven cross section. A grooved portion is referred to as a “pit”, and a smooth (not indented) portion is referred to as a “land”. On the disk D16, data is recorded as combinations of pits and lands. Specifically, data is recorded depending on the pit length and the land length.

The reflecting layer 102 is given an uneven cross section in accordance with the shapes of pits and lands by being laminated onto the substrate 101. The reflecting layer 102 is, for example, a metal layer. By irradiating the reflecting layer 102 with a laser beam gathered by an objective lens via the covering layer 103, as shown in FIG. 1, the reflected light in accordance with the unevenness is obtained. On the basis of the reflected light of the laser beam reflected from the reflecting layer 102, a recording apparatus 50 (which will be described later) can read data recorded as combinations of pits and lands.

For the primary data recording disk D16 of the embodiment, the material of the reflecting layer 102 is chosen so that the material property of the reflecting layer 102 does not change due to irradiation of a laser beam of playback power, but when being irradiated with a laser beam of recording power that is sufficiently higher than the playback power, the reflecting layer 102 is melted and the material property thereof changes.

For general optical disk recording media, aluminum is used as the material of a reflecting layer. For the primary data recording disk D16, for example, an alloy of aluminum and titanium or an alloy including silver is selected as the material of the reflecting layer 102.

With regard to the reflecting layer 102 made of such a material, the following experimental results are obtained. That is, when the reflecting layer 102 is irradiated with a laser beam of the above-described predetermined recording power, the reflectively of land portions approaches that of pit portions. As a result, the playback signal level in the land portions decreases to a level regarded as the playback signal level in the pit portions. The following are the conceivable causes of the above. Specifically, the reflecting layer 102 is melted when being irradiated with a laser beam of the above-described recording power, and as a result, the oxidation state and crystalline state (amorphous state) of the metal layer change. In addition, the substrate 101 and/or the covering layer 103 in contact with the reflecting layer 102 are/is heated by laser irradiation of high output, which results in a change of the shape of the substrate 101 and/or the covering layer 103.

According to the experiment, the following results are obtained. When the disk 16 including the reflecting layer 102 made of the above-described material according to the embodiment is irradiated with a laser beam by changing the laser power from the recording power for making the reflectivity of the land portions approach that of the pit portions, the reflectivity of the pit portions approach that of the land portions, and as a result, the playback signal level in the pit portions increases to a level regarded as the playback signal level in the land portions. As the principles or causes thereof, a change in the oxidation state and crystalline state of the reflecting layer 102 due to irradiation with a laser beam of high output and a change in the shape of the substrate 101 and/or the covering layer 103 are conceivable.

Hereinafter, the case in which the reflectivity of the land portions approaches that of the pit portions and the playback signal level in the land portions decreases to a level regarded as the playback signal level in the pit portions is referred to as “making lands into pits”, and conversely the case in which the reflectivity of the pit portions approaches that of the land portions and the playback signal level in the pit portions increases to a level regarded as the playback signal level in the land portions is referred to as “making pits into lands”.

For the sake of confirmation, it is to be understood that, in the embodiment of the present invention, an evaluation value is calculated on the basis of the results of measuring the amounts of edge shifts induced by making lands into pits or by making pits into lands in edge portions of the lands or pits, and the principle of inducing the edge shifts is not limited. That is, the present invention is also preferably applicable to the case in which edge shifts are induced by making pits into lands or by making lands into pits on the basis of elements and principles other than those described above.

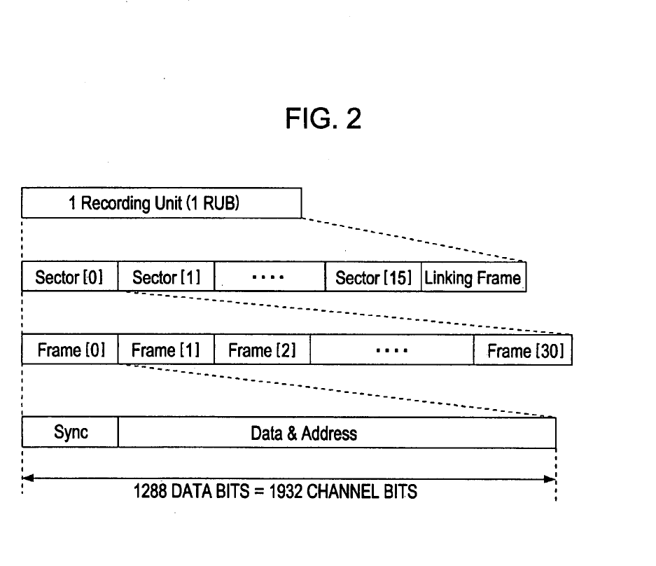

FIG. 2 shows the data structure of primary data recorded on the primary data recording disk D16.

As shown in FIG. 2, one recording unit referred to as RUB is defined. One RUB includes 16 sectors and 2 linking frames. Each linking frame is provided as a buffering area between two RUBs.

Each sector includes, as shown in FIG. 2, 31 frames. One frame has 1288 data bits. In this case, one frame forms one address unit.

The primary data is recorded on the disk 16 of the embodiment subsequent to being subjected to run-length-limited (RLL) (1,7) parity preserve/prohibit (PP) modulation and then being subjected to non-return-to-zero-inverse (NRZI) modulation, which will be described below. Therefore, as shown in FIG. 2, one frame has a 1932-channel-bit area for modulated data to be actually recorded.

In the above-described RLL (1,7) PP modulation, the run length of symbols “0” and “1”, namely the pit length and the land length, is limited to lengths ranging from 2 T (channel bits) to 8 T. In sync at the beginning of each frame, a 9 T symbol string that does not conform to the RLL (1,7) PP modulation rule is inserted for use in detecting a frame sync signal.

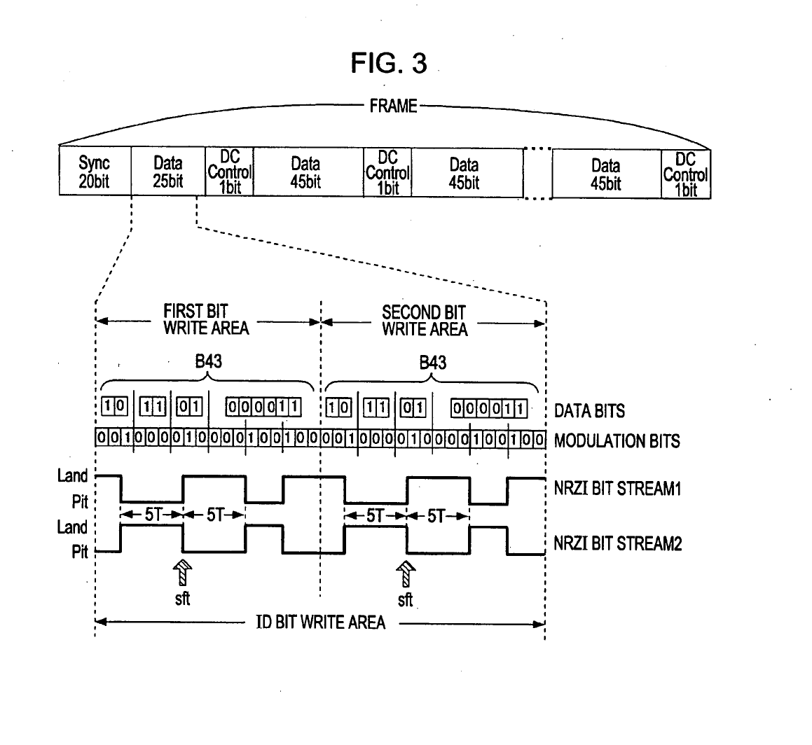

FIG. 3 shows the data structure in one frame shown in FIG. 2.

As shown in FIG. 3, one frame stores a 25-data-bit data area subsequent to “sync”, which is also shown in FIG. 2, and a 1-data-bit DC control bit. In this case, sync has 20 data bits of unmodulated data.

Subsequent to the DC control bit subsequent to the 25-data-bit area, a pattern including a 45-data-bit data area and a 1-data-bit DC control bit is repeated for one frame shown in FIG. 2, that is, for a total of 1288 data bits.

In the embodiment, one frame has such a structure. In addition, the 25-data-bit data area subsequent to the above-described sync has, at the beginning thereof, a 24-data-bit area allocated for an ID bit write area for writing values of bits forming secondary data different from the above-described primary data. This ID bit write area includes, in the embodiment, two areas including a first bit write area and a second bit write area. Accordingly, two secondary data values can be recorded in every frame.

In this case, identification information (may also be referred to as “ID bits”) allocated so as to be unique to each disk D16 is recorded as the secondary data.

Since a total of 24 data bits are divided into two areas, 12 data bits are allocated to each bit write area. As shown in FIG. 3, the value B43 (hexadecimal notation) is stored in each bit write area. Accordingly, when data in each bit write area is RLL-(1,7)-PP-modulated, NRZI-modulated, and actually recorded as pits and lands on the disk D16, as shown in FIG. 3, a section in which a 5 T land and a 5 T pit are adjacent to each other is obtained.

Specifically, B43 (101101000011) is RLL-(1,7)-PP-modulated to yield “001000010000100100” shown in FIG. 3 as modulation bits. A recording waveform subsequent to the NRZI modulation includes, as shown by NRZI bit stream 1 and NRZI bit stream 2 in FIG. 3, either a combination of a 5 T pit and a 5 T land or a combination of a 5 T land and a 5 T pit. As a result, a section in which a 5 T land and a 5 T pit are adjacent to each other is obtained.

It is necessary to assume, for the same modulation bits, that there are NRZI bit stream 1 and NRZI bit stream 2 with different polarities because, depending on the value of the end bit in the immediately preceding frame, the polarity of NRZI at the beginning of the first bit write area may be different.

2. Recording Method

In the embodiment, as described above, a section in which a land and a pit of a predetermined length are adjacent to each other is included in each of the first bit write area and the second bit write area in each ID bit write area, and the boundary between the land and the pit is shifted/not shifted, thereby recording a value of the identification information.

That is, a value of the identification information is recorded in such a manner that “1” is recorded when a portion in which the edge is to be shifted in FIG. 3 (hereinafter referred to as an “edge-to-be-shifted portion sft”) is shifted, whereas “0” is recorded when the edge-to-be-shifted portion sft is not shifted.

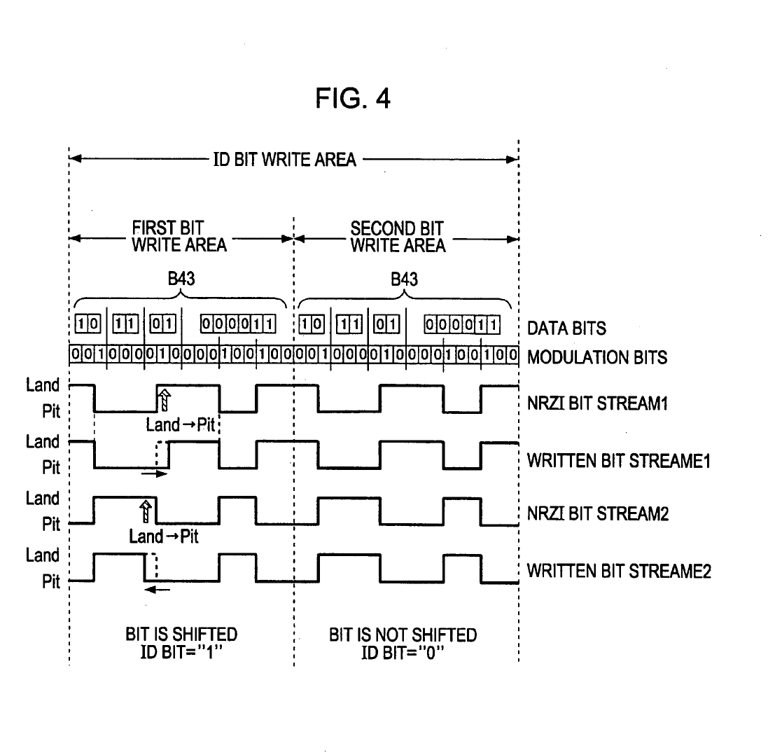

FIG. 4 shows a specific example of the recording operation of identification information (secondary data) according to the embodiment.

In the following description including FIG. 4, an example is described in which an edge shift is induced by making a land edge portion serving as the edge-to-be-shifted portion sft into a pit. In this case, the edge is shifted by an amount of 1 T.

FIG. 4 shows, as in FIG. 3, the relationships among the data value (data bits) stored in the ID bit write area, modulation bits based on the data bits, and recording waveforms of NRZI bit stream 1 and NRZI bit stream 2 of opposite polarities which are conceivably obtained on the basis of the modulation bits.

In this case, as described above, an edge shift is induced by making a land edge portion into a pit. In either of NRZI bit stream 1 and NRZI bit stream 2, an edge shift is induced by irradiating the land edge portion with a laser beam of recording power, thereby performing recording.

It should be taken into consideration that irradiation of a laser beam is performed with different timing in the case of the polarity of NRZI bit stream 1 and the case of the polarity of NRZI bit stream 2.

In other words, as shown in FIG. 4, in the case of the polarity of NRZI bit stream 1, the appropriate laser irradiation point in each of the first bit write area and the second bit write area is the eighth channel bit from the beginning thereof, whereas the appropriate laser irradiation point in the case of the polarity of NRZI bit stream 2 is the seventh channel bit from the beginning thereof.

When this is taken into consideration, it is necessary irradiation of a laser beam is performed at the seventh channel bit from the beginning of the first bit write area, thereby appropriately shifting the land edge portion serving as the edge-to-be-shifted portion sft.

With such operation, in this case, “1” is recorded only in the first bit write area. As a result, the above-described “1” and “0” are recorded in the ID bit write area.

Although FIG. 4 shows the ID bit write area only in one frame, ID bit write areas are similarly provided in other frames. By performing such recording operation in a plurality of frames, all the values forming the identification information can be recorded.

Determination of the recorded value, that is, playback of the identification information, can be performed in the following manner.

At the playback apparatus side, data (primary data) recorded in the ID bit write area in each frame is played back.

In the embodiment, as shown in FIG. 3, the position of the ID bit write area and the data value that should be stored therein are defined by the format. This allows the playback apparatus to recognize the position of the ID bit write area. Similarly, the playback apparatus can recognize in advance the value of data (primary data) stored in each bit write area in the ID bit write area.

The playback apparatus plays back data in the ID bit write area and compares, in each bit write area, the played-back data with the data value (B43 in this case) that should be stored in that bit write area.

When the played-back data in the bit write area agrees with B43, it is determined that no edge shift has been induced, that is, “0” has been recorded. In contrast, when the played-back data disagrees with B43, it is determined that an edge shift has been induced, that is, “1” has been recorded.

In this manner, the identification information can be played back.

As in the above description, the fact that two values of the identification information can be recorded in each frame means that a maximum number of bits obtained by multiplying the number of frames by two can be recorded. However, this does not necessarily mean that the identification information should be recorded in all the frames. For example, when the number of bits to be recorded as the identification information is less than or equal to the total number of frames×2, the identification information may be recorded in some of the frames, the number of which is sufficient for recording all the bits forming the identification information.

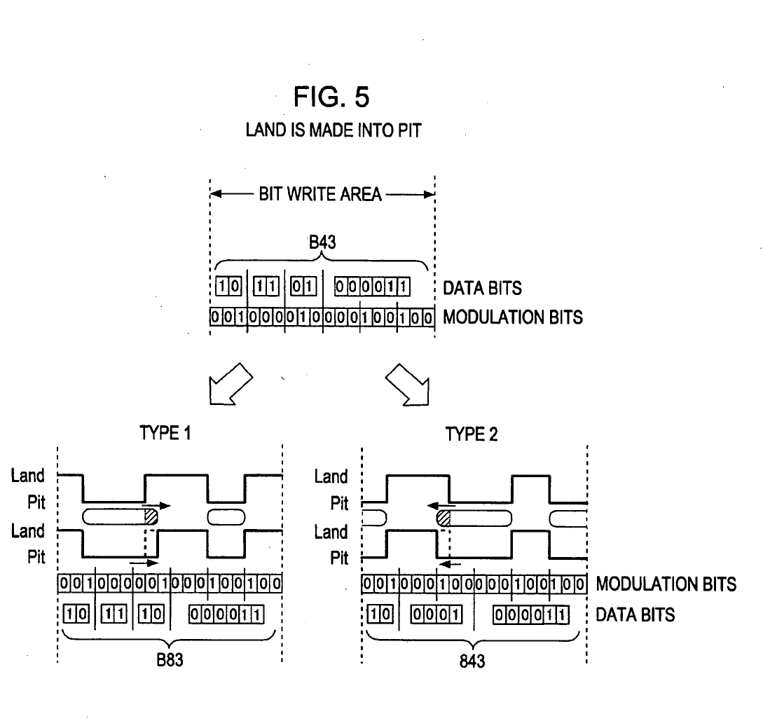

For the sake of reference, FIG. 5 shows the appearance of the disk when an edge shift is induced, recording waveforms subsequent to the edge shift, and the values of modulation bits and data bits obtained as a result thereof.

In FIG. 5, the recording waveform designated as “type 1” corresponds to, as can be understood with reference to FIGS. 3 and 4, the recording waveform in each bit write area with the polarity of NRZI bit stream 1.

The recording waveform designated as “type 2” corresponds to the recording waveform in each bit write area with the polarity of NRZI bit stream 2. It is thus made clear that the recording waveform in each bit write area in this case may be one of these two types.

When the recording waveform is of the above-described type 1, the modulation bits subsequent to the edge shift has a value of, as shown in FIG. 5, “001000001000100100”. When the recording waveform is of the above-described type 2, the modulation bits subsequent to the edge shift has a value of “001000100000100100”.

When demodulated in accordance with the RLL (1,7) PP modulation rule, as shown in FIG. 5, these values are demodulated into B82 (101110000011) and 843 (100001000011), respectively. In the embodiment, the value that should be stored in each byte in the ID bit write area is set to satisfy the condition that the value obtained after the shift can be properly RLL-(1,7)-PP-demodulated, that is, the value follows the modulation rule. This prohibits a situation in which the playback apparatus has difficulty playing back the primary data because the data does not follow the modulation rule.

In this embodiment, according to the description so far, B43 is set as the data value to be stored in each bit write area in the ID bit write area. Accordingly, the edge-to-be-shifted portion sft in each bit write area is the edge portion between a land and a pit of 5 T, and the value of the modulation bits obtained subsequent to the edge shift follows the modulation rule.

In the embodiment, the fact that the edge-to-be-shifted portion sft is the edge portion between a land and a pit of a relatively long amount of 5 T is because, when the land length and the pit length of the edge-to-be-shifted portion sft are relatively long, the possibility of influencing a nontarget edge in the case where, for example, the area to be deformed by laser irradiation is increased, can be reduced. In other words, the incidence of recording error of the identification information can be reduced.

In this case, the longer the land length and the pit length of the edge-to-be-shifted portion sft, the more effectively the occurrence of recording error is prevented. In other words, the land length and the pit length in this case are not limited to 5 T. By setting the land length and the pit length to a longer length, the occurrence of recording error can be more reliably prevented.

In the embodiment, B43 serving as the data value to be stored in each bit write area is one example of a value that satisfies the following two conditions: one condition that the edge-to-be-shifted portion sft is the edge portion between a land and a pit having a predetermined length or longer in order to prevent such recording error; and the other condition that the modulation bits subsequent to the edge shift follow the modulation rule. An arbitrary value can be set as the data value as long as these conditions are met.

Another example of the data value will be described in modifications below.

As described above, in this example, a land edge portion serving as the edge-to-be-shifted portion sft is made into a pit to induce an edge shift. In contrast, it is conceivable that recording by inducing an edge shift can be similarly performed by making a pit edge portion serving as the edge-to-be-shifted portion sft into a land.

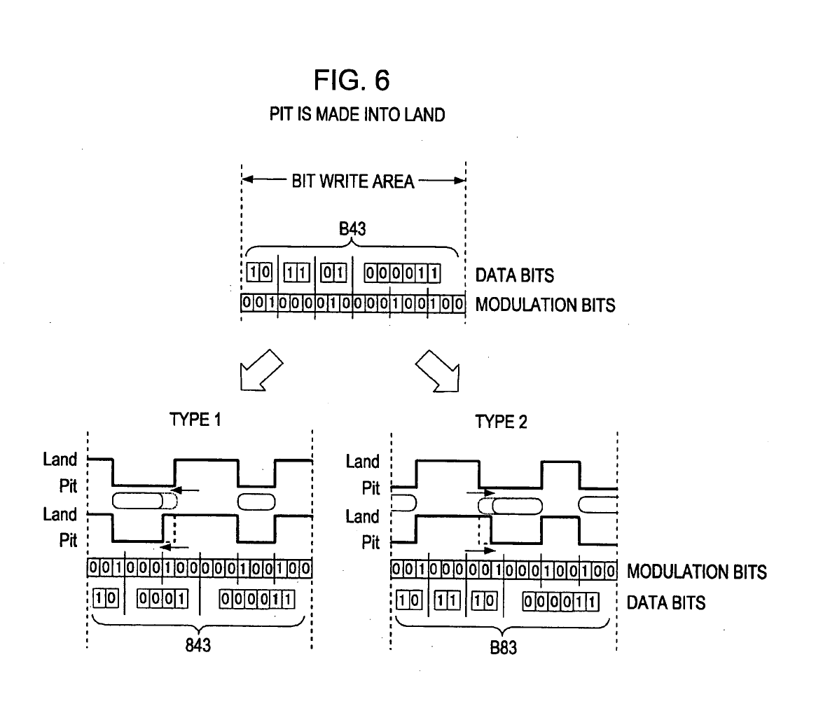

FIG. 6 is a diagram showing the appearance of the disk when an edge shift is induced by making a pit into a land, recording waveforms subsequent to the edge shift, and the values of modulation bits and data bits obtained as a result thereof, which are similar to those shown in FIG. 5.

In this case, the recording waveform of type 1 shown in FIG. 6 is the recording waveform in each bit write area with the polarity of NRZI bit stream 1, and the recording waveform of type 2 is the recording waveform in each bit write area with the polarity of NRZI bit stream 2.

As shown in FIG. 6, in the case where an edge shift is induced by making a pit into a land, the pit edge portion serving as the edge-to-be-shifted portion sft is irradiated with a laser beam. In contrast to the case where the land edge portion is irradiated, the edge shift position in the case of type 1 (polarity of NRZI bit stream 1) is the seventh channel bit from the beginning of each bit write area; and the edge shift position in the case of type 2 (polarity of NRZI bit stream 2) is the eighth channel bit from the beginning of each bit write area.

In the case of type 1, modulation bits subsequent to an edge shift induced by making a pit into a land has a value of, as shown in FIG. 6, “001000100000100100”. In the case of type 2, modulation bits subsequent to an edge shift has a value of “001000001000100100”. These values of modulation bits can be RLL-(1,7)-PP-demodulated into, as shown in FIG. 6, 843 (100001000011) and B83 (101110000011), respectively.

That is, according to the data value B43 stored in each bit write area in this case, even when an edge shift is induced by making a pit into a land, it is possible to obtain the value of modulation bits subsequent to the edge shift following the RLL (1,7) PP modulation rule.

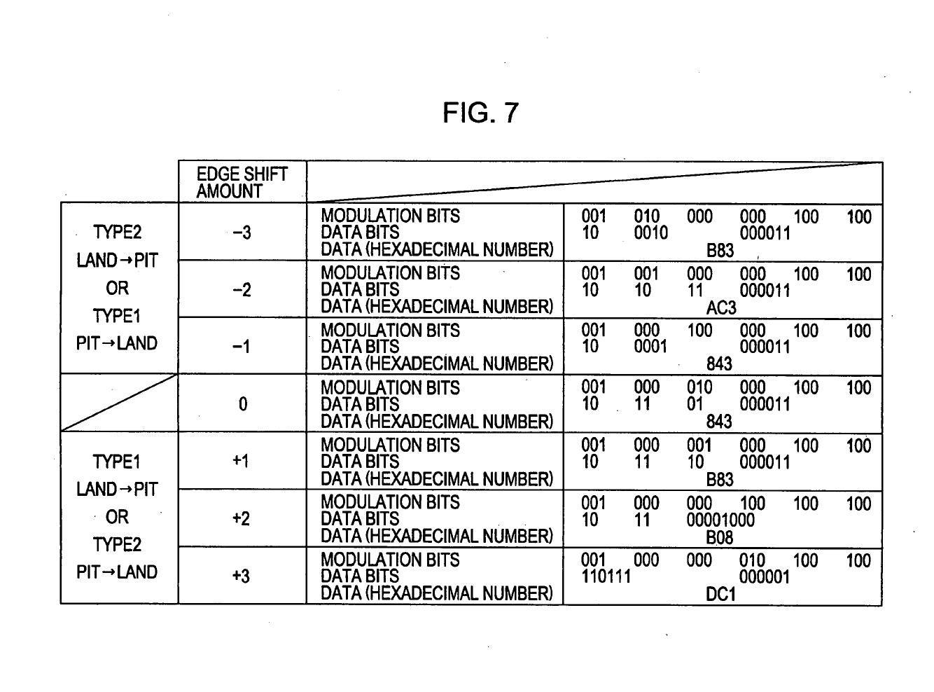

For the sake of reference, FIG. 7 shows all possible modes of edge shifts according to the data value B43 stored in each bit write area in this case.

In FIG. 7, all possible modes of edge shifts are indicated by amounts of positive and negative edge shifts. For example, when the edge shift amount is “+”, it means that the position of the edge-to-be-shifted portion sft is shifted in the positive direction (in the forward direction with respect to the playback direction). That is, the modes of “+” edge shift amounts correspond to the case in which an edge shift is induced by making a land into a pit in the case of type 1 shown in FIG. 5 (polarity of NRZI bit stream 1 in FIG. 4) and the case in which an edge shift is induced by making a pit into a land in the case of type 2 shown in FIG. 6 (polarity of NRZI bit stream 2).

In contrast, when the amount of edge shift is “−”, it means that the position of the edge-to-be-shifted portion sft is shifted in the negative direction (in the reverse direction with respect to the playback direction). Specifically, these edge shift modes correspond to the case in which an edge shift is induced by making a land into a pit in the case of type 2 shown in FIG. 5 (polarity of NRZI bit stream 2) and the case in which an edge shift is induced by making a pit into a land in the case of type 1 shown in FIG. 6 (polarity of NRZI bit stream 1).

As can be understood with reference to FIG. 7, according to B43 in the embodiment, edge shifts of up to 3T can be handled both in the cases in which a land is made into a pit and a pit is made into a land.

Specifically, in the case in which a land is made into a pit and the recording waveform is of type 1, as the amount of edge shift increases in the order of +1 T, +2 T, and +3 T, modulation bits subsequent to the edge shift have values of “001000001000100100”, “001000000100100100”, and “001000000010100100”, which can be RLL-(1,7)-PP-demodulated into the data bit values B83 (101110000011), B08 (101100001000), and DC1 (110111000001), respectively. In the case of the recording waveform of type 2, as the amount of edge shift increases in the order of −1 T, −2 T, and −3 T, modulation bits subsequent to the edge shift have values of “001000100000100100”, “001001000000100100”, and “001010000000100100”, which can be RLL-(1,7)-PP-demodulated into the data bit values 843 (100001000011), AC3 (101011000011), and 883 (100010000011), respectively.

Accordingly, in the case in which a land is made into a pit, modulation bits that follow the modulation rule within the range of shift amounts from 1 T to 3 T can be obtained in both cases of the recording waveforms of type 1 and type 2. In other words, the range from 1 T to 3 T can be handled.

In the case in which a pit is made into a land and the recording waveform is of type 1, as the amount of edge shift increases in the order of −1 T, −2 T, and −3 T, modulation bits subsequent to the edge shift have the same values as those in the above-described case in which a land is made into a pit and the recording waveform is of type 2. Accordingly, edge shifts of up to 3 T can also be handled in this case.

In the case in which a pit is made into a land and the recording waveform is of type 2, as the amount of edge shift increases in the order of +1 T, +2 T, and +3 T, modulation bits subsequent to the edge shift have the same values as those in the above-described case in which a land is made into a pit and the recording waveform is of type 1. Accordingly, edge shifts of up to 3 T can also be handled in this case.

Therefore, even when pits are made into lands, edge shifts of 1 T to 3 T can be handled.

3. Recording Apparatus

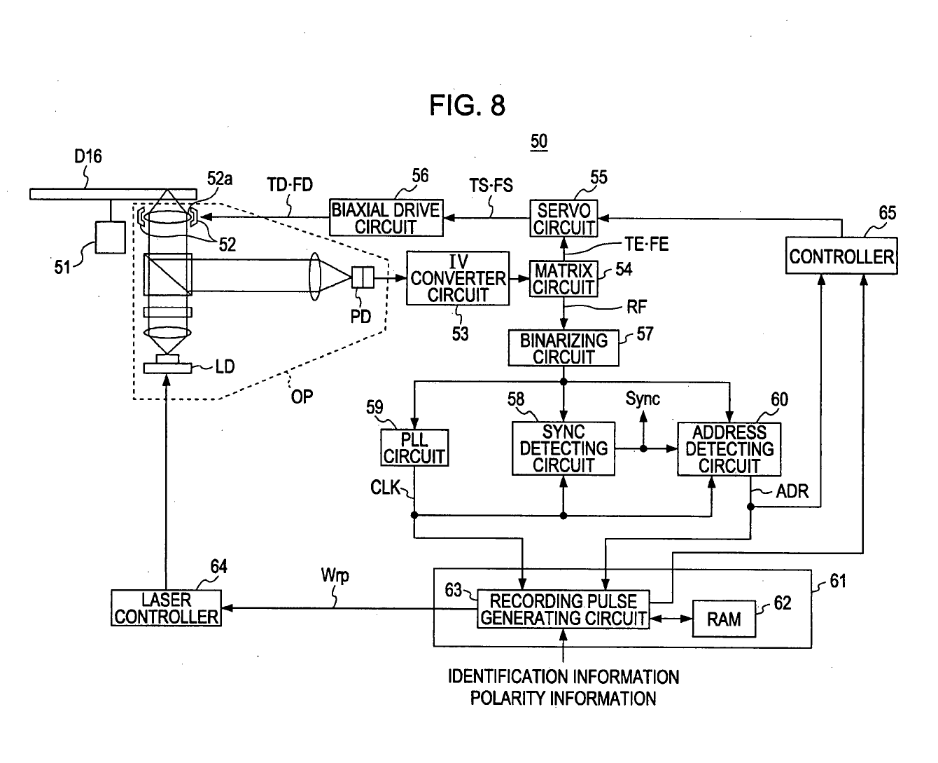

With reference to FIG. 8, an example of the configuration of a recording apparatus for implementing the recording operation according to the embodiment described as above will be described.

The primary data recording disk D16, which is a ROM disk, is placed on a turntable (not shown) and rotated by a spindle motor 51 in accordance with a predetermined rotating and driving method. An optical pickup OP (shown in FIG. 8) reads a recorded signal (recorded data) from the rotated disk D16.

The optical pickup OP includes a laser diode LD serving as the laser source in FIG. 8, an objective lens 52a for gathering a laser beam and irradiating a recording surface of the disk D16, and a photodetector PD for detecting the light reflected from the disk D16 due to the laser irradiation.

The optical pickup OP further includes a biaxial mechanism 52 for movably holding the objective lens 52a in the focusing and tracking directions. The biaxial mechanism 52 drives the objective lens 52a in the focusing and tracking directions on the basis of a focusing drive signal FD and a tracking drive signal TD from a biaxial drive circuit 56 described below.

For the sake of confirmation, the focusing direction is the contacting/separating direction to/from the disk D16.

In this case, the disk D16 is recorded/played back with a laser wavelength λ of 405 nm and the objective lens 52a having a numerical aperture (NA) of 0.85.

The reflected light information detected by the photodetector PD in the optical pickup OP is converted by an IV converter circuit 53 into an electrical signal, and the electrical signal is supplied to a matrix circuit 54. On the basis of the reflected light information from the IV converter circuit 53, the matrix circuit 54 generates a playback signal RF, a tracking error signal TE, and a focusing error signal FE.

In response to the tracking error signal TE and the focusing error signal FE from the matrix circuit 54, a servo circuit 55 performs predetermined operations such as filtering and loop gain processing for phase compensation to generate a tracking servo signal TS and a focusing servo signal FS. The servo circuit 55 supplies the tracking servo signal TS and the focusing servo signal FS to the biaxial drive circuit 56.

On the basis of the tracking servo signal TS and the focusing servo signal FS, the biaxial drive circuit 56 generates the tracking drive signal TD and the focusing drive signal FD and supplies these signals TS and FD to a tracking coil and a focusing coil.

The photodetector PD, the IV converter circuit 53, and the matrix circuit 54 form a tracking servo loop, and the servo circuit 55, the biaxial drive circuit 56, and the biaxial mechanism 52 form a focusing servo loop. With the tracking servo loop and the focusing servo loop, control is performed so that the spot of a laser beam irradiated on the disk D16 traces a pit sequence (recording track) formed on the disk D16 and is maintained in an appropriate focused state.

The playback signal RF generated by the matrix circuit 54 is supplied to a binarizing circuit 57 and converted into binary data “0” and “1”. The binary data is supplied to a sync detecting circuit 58, a phase locked loop (PLL) circuit 59, and an address detecting circuit 60.

The PLL circuit 59 generates a clock CLK in synchronization with the supplied binary data and supplies this clock CLK as the operation clock necessary for each part. In particular, the clock CLK is also supplied as the operation clock for the binarizing circuit 57, the sync detecting circuit 58, the address detecting circuit 60, and a recording pulse generator 61, which will be described below.

The sync detecting circuit 58 detects, from the supplied binary data, a sync pattern inserted in each frame shown in FIG. 2. Specifically, the sync detecting circuit 58 detects a 9 T section, which is regarded as a sync pattern in this case, and performs frame sync detection.

The frame sync signal is supplied to each necessary part, such as the address detecting circuit 60.

The address detecting circuit 60 detects address information ADR on the basis of the frame sync signal and the supplied binary data. The detected address information ADR is supplied to a controller 65. The address information ADR is also supplied to a recording pulse generating circuit 63 in the recording pulse generator 61.

The recording pulse generator 61 includes, as shown in FIG. 8, the recording pulse generating circuit 63 and a random access memory (RAM) 62.

Identification information (ID bits) that should be additionally recorded on the disk D16 and polarity information indicating the polarity of NRZI in each frame are input from the outside to the recording pulse generator 61. In addition, the address information ADR from the address detecting circuit 60 and the clock CLK from the PLL circuit 59 are supplied to the recording pulse generator 61.

To implement the above-described operation of recording the identification information according to the embodiment, it is necessary to input values of the identification information that should be additionally recorded and the polarity information of NRZI in each frame to the recording apparatus 50. In other words, the input of the identification information values enables a determination whether to induce an edge shift in each bit write area in each frame. In association with the fact that, as described above, the edge shift position differs (the eighth or seventh channel bit from the beginning of each bit write area) depending on the polarity of NRZI, the polarity information of NRZI is information necessary for inducing an edge shift at the correct position in accordance with the NRZI polarity.

For the sake of confirmation, the recording apparatus 50 in this case is an apparatus managed by a manufacturer of the primary data recording disk D16 (disk 100). It is thus possible to detect in advance the recoding data values to be recorded on the disk D16, which is a ROM disk. Since the recording data values to be recorded on the disk D16 can be detected in advance, the polarity information of NRZI in each frame can also be detected in advance by the manufacturer.

In the recording pulse generator 61, the identification information values and the polarity information are input to the recording pulse generating circuit 63. The recording pulse generating circuit 63 stores the identification information values and the polarity information in each frame (at each address) in the RAM 62.

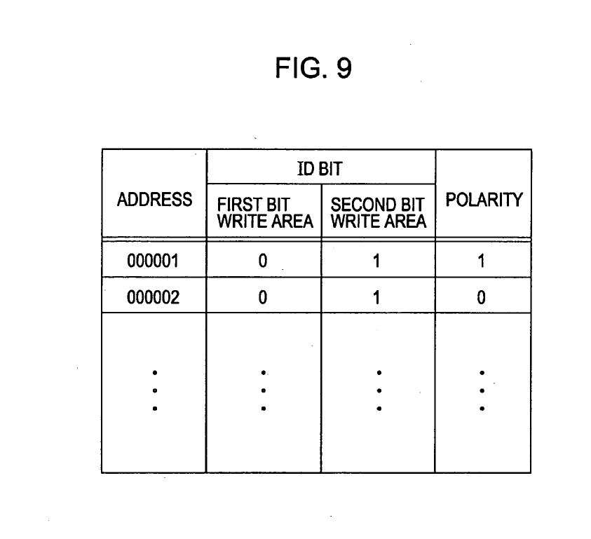

FIG. 9 shows data content stored in the RAM 62.

As shown in FIG. 9, the input identification information values are stored by being allocated to each bit write area at each address (in each frame). In addition, information indicating the polarity of NRZI is stored with respect to each address.

In this case, the polarity information “1” indicates to recognize the polarity information of NRZI in a frame to be recorded in order that the appropriate edge shift can be induced.

For example, in this case, it is assumed that, as a value of the identification information, “1” is recorded in the first bit write area, and “0” is recorded in the second bit write area.

In this case, on the basis of the identification information value allocated in each of the bit write areas, it is determined whether to induce an edge shift in that bit write area. That is, in this case, it is determined on the basis of the above-described allocated values “1” and “0” that an edge shift is to be induced in the first bit write area.

Depending on the polarity of the NRZI bit stream in the frame to be recorded, the appropriate edge shift position differs. It is thus necessary to perform irradiation of a laser beam at the appropriate position in accordance with the polarity thereof in the frame. That is, in the case of the polarity of NRZI bit stream 1, as shown in FIG. 4, irradiation of a laser beam is performed at the eighth channel bit from the beginning of the first bit write area, thereby appropriately shifting the land edge portion serving as the edge-to-be-shifted portion sft.

In the case of the polarity of NRZI bit stream 2, the polarity of the above-described NRZI bit stream 1, and “0” indicates the polarity of NRZI bit stream 2.

Referring back to FIG. 8, the recording pulse generating circuit 63 generates a recording pulse signal Wrp that becomes high only at the edge shift position, which will be described below, on the basis of the information stored in the RAM 62, which is shown in FIG. 9, the clock CLK, and the address information ADR.

On the basis of the recording pulse signal Wrp output from the recording pulse generating circuit 63, a laser controller 64 controls the laser power of the laser diode LD in the optical pickup OP. Specifically, the laser controller 64 in this case controls the laser diode LD so that the laser output of playback power can be obtained when the recording pulse signal Wrp is at the low level and, when the recording pulse signal Wrp is at the high level, the laser output of recording power can be obtained. In this case, it is assumed that an edge shift is induced by making a land into a pit, and the recording power is set to the laser power capable of making a land into a pit in such a manner.

The controller 65 includes, for example, a microcomputer and performs the overall control of the recording apparatus 50.

For example, the controller 65 indicates a target address to the servo circuit 55, thereby performing seeking operation control. In other words, by designating a target address, the controller 65 allows the servo circuit 55 to perform an access operation of the optical pickup OP targeted at the target address.

By giving a track-jump command to the servo circuit 55, the controller 65 may allow the servo circuit 55 to turn off the tracking servo loop and perform a track-jump operation.

The recording apparatus 50 having the above-described configuration performs the following operation to additionally record the identification information on the primary data recording disk D16.

As described above, the case of inducing an edge shift by making a land into a pit is described by way of example.

On the basis of the identification information values at each address (in each frame) stored in the RAM 62, the recording pulse generating circuit 63 shown in FIG. 8 specifies the bit write area in each frame to be recorded in which an edge shift is to be induced.

On the basis of the information “0” and “1” stored with respect to a frame, the recording pulse generating circuit 63 determines the polarity of NRZI in that frame.

Having done so, the recording pulse generating circuit 63 recognizes the edge shift position in the ID bit write area on the basis of the specified bit write area information and the polarity information.

In this case, when the polarity is “1”, it is clear that the edge shift position in both the first bit write area and the second bit write area is the eighth channel bit from the beginning thereof. When the polarity is “0”, the edge shift position in both the first bit write area and the second bit write area is the seventh channel bit from the beginning thereof.

On the basis of such information and the information on the specified bit write area in which an edge shift is to be induced, the appropriate edge shift position can be recognized.

Having recognized the appropriate edge shift position in accordance with the values allocated to each frame and the polarity information, the recording pulse generating circuit 63 generates, in each frame, a data sequence for one frame having “1”, at the recognized edge shift position and “0s” at the remaining positions.

Specifically, for example, on the assumption that “1” is recorded as the identification information value in all the bit write areas in a certain frame and that the polarity of that frame is “1”, in the case where one frame has 1932 channel bits, a data sequence for one frame having “1” at the eighth channel bit from the beginning of each bit write area and “0s” at the remaining 1930 channel bits is generated.

The recording pulse generating circuit 63 generates such a data sequence for all the frames in which the identification information is to be recorded.

In the actual recording, while the primary data recording disk D16 is being played back, the recording pulse generating circuit 63 supplies the recording pulse signal Wrp, which becomes low when the value is “0” and which becomes high when the value is “1” on the basis of the data sequence, to the laser controller 64.

As has been described above, the laser controller 64 controls the laser output of the laser diode LD so that the laser output is of the playback power when the recording pulse signal Wrp is low and is of the recording power when the recording pulse signal Wrp is high. Accordingly, on the primary data recording disk D16, only portions in which edge shifts are to be induced can be irradiated with a laser beam of the recording power, thereby appropriately recording the input identification values on the disk D16.

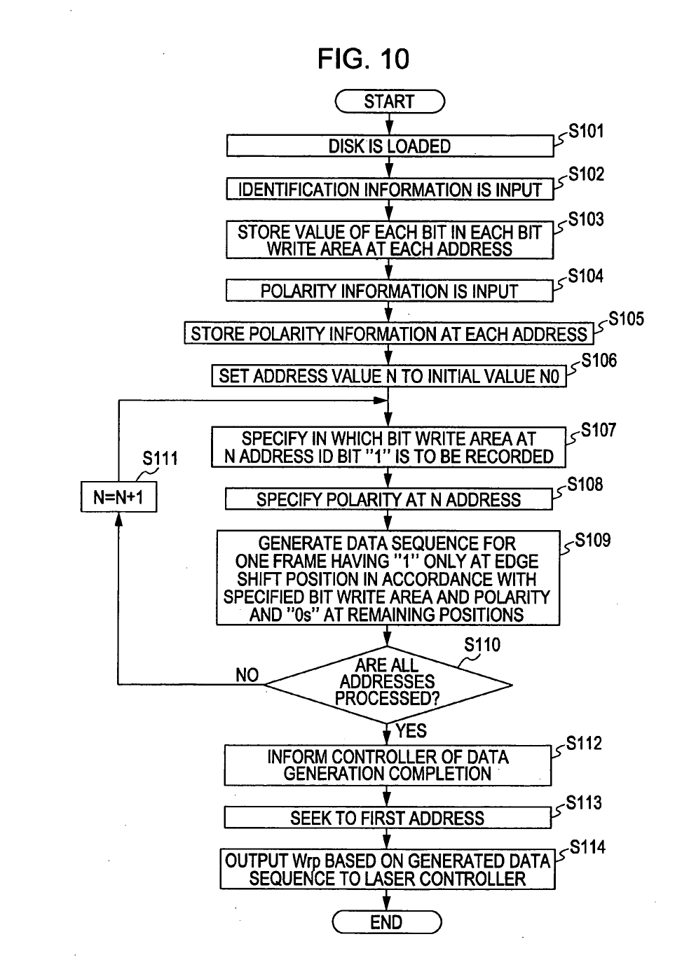

With reference to the flowchart of FIG. 10, the operation of the recording apparatus 50 for recording identification information in this case will be described in detail.

Referring to FIG. 10, in step S101, the primary data recording disk D16 is loaded.

In step S102, values of identification information to be additionally recorded are input.

In step S103, the recording pulse generating circuit 63 stores the input identification information values with respect to each bit write area at each address.

For example, in this case, the identification information values are sequentially allocated to frames, starting from the first frame. In step S103, the input values are sequentially stored in storage areas for the corresponding bit write areas in the frames in the RAM 62.

In step S104, polarity information is input. In step S105, the recording pulse generating circuit 63 stores the polarity information with respect to each address.

Since the polarity information is the information indicating the polarity of NRZI at each address, the recording pulse generating circuit 63 stores the values “0” and “1” indicating the polarities in the storage areas in the RAM 62 shown in FIG. 9 so that the correspondence relationship can be maintained.

The input and storage of the polarity information may be performed prior to the input and storage of the identification information.

Although the case in which the identification information values and the polarity information are separately input has been described by way of example, the identification information values and the polarity information that are simultaneously input may be stored by separate storage operations.

Although in this case the identification information and the polarity information are input after the disk D16 has been loaded, the information may be input prior to the loading of the disk D16.

In step S106, the address value N is set to the initial value NO.

The operation in step S106 is performed by the recording pulse generating circuit 63 to set the internal counter value to the initial value NO in order to generate a data sequence for each address, which will be described below.

In step S107, the recording pulse generating circuit 63 performs an operation to specify the bit write area at the N address in which “1” is to be recorded as the identification information value (ID bit). That is, the operation of the recording pulse generating circuit 63 in step S107 involves referring to the identification information value to be stored in each bit write area at the N address in the RAM 62 and specifying the bit write area in which the value is “1”.

In step S108, the polarity at the N address is determined. In other words, the recording pulse generating circuit 63 determines whether the value indicating the polarity, which is stored with respect to the N address in the RAM 62, is “0” or “1”.

In step S109, the recording pulse generating circuit 63 generates a data sequence for one frame having “1” at the edge shift position in accordance with the specified bit write area and the polarity and “0s” at the remaining positions.

As has been described above, when the polarity is “1”, the land edge portion serving as the edge-to-be-shifted portion sft is the eighth channel bit from the beginning both in the first bit write area and the second bit write area. When the polarity is “0”, the edge portion is the seventh channel bit from the beginning both in the first bit write area and the second bit write area.

On the basis of the bit write area information specified in step S107 and the polarity information determined in step S109, the recording pulse generating circuit 63 can specify the edge shift position.

The recording pulse generating circuit 63 generates a data sequence for one frame having “1”, at the edge shift position, which can be specified in accordance with the specified bit write area and the polarity, and “0s” at the remaining positions.

The data sequence for each frame generated in step S109 is held with respect to each address in the RAM 62 or the like since it will be used later to generate the recording pulse signal Wrp.

Having generated the data sequence for one frame, the recording pulse generating circuit 63 determines whether all the addresses have been processed (S110). That is, it is determined whether the data sequence has been completely generated for all the frames allocated in advance for recording the identification information. The operation in step S110 is performed by determining whether the counter value, which has been set to the initial value NO in step S106 by the recording pulse generating circuit 63, has reached a predetermined value.

When the determination is negative meaning that the counter value has not reached the predetermined value, the address value N is incremented by one (step S111), and the operation returns to step S107. Accordingly, the data sequence is generated for all the frames allocated to record the identification information.

When it is determined in step S110 that the counter value has reached the predetermined value and all the addresses have been processed, in step S112, the controller 65 shown in FIG. 8 is informed of the completion of the data generation. That is, in response to the fact that the data sequence has been completely generated for all the frames, the recording pulse generating circuit 63 informs the controller 65 of the completion of the data generation.

In response to this notification, the controller 65 performs a control operation for seeking to the first frame (address) allocated to record the identification information (step S113). This seeking operation can be performed by the controller 65 designating a target address to the servo circuit 55 on the basis of the address information of the first frame on the disk D16, which has been stored therein in advance.

In response to the seeking operation to the first address, the recording pulse generating circuit 63 outputs the recording pulse signal Wrp based on the data sequence generated for each frame in step S109 (step S114). The recording pulse signal Wrp based on the data sequence is output on the basis of the timing of the clock CLK so as to synchronize with data to be played back. The output of the recording pulse signal Wrp can be started in response to the supply of information indicating the first address serving as the address information ADR supplied by the address detecting circuit 60.

The recording pulse signal Wrp output in step S114 is obtained as a signal that becomes high only at the appropriate edge shift positions based on the input identification information values and the polarity information. That is, on the basis of the recording pulse signal Wrp, the laser controller 64 controls the laser output of the laser diode LD to change from the playback power to the recording power, thereby appropriately recording the input identification information values on the disk D16.

Although in FIG. 10 the identification information values are input from the outside, a circuit for generating a new serial number every time the disk D16 is loaded may be provided, and identification information values output by the circuit may be sequentially stored in the RAM 62.

With regard to the polarity information, the disks D16 having the same title, meaning that the same data is recorded, have the same correspondence of the frame to the polarity. For such disks D16 having the same title, the processing to input and store the polarity information (steps S104 and S105), which is performed every time the disk is loaded, as shown in FIG. 10, may be omitted.

4. Secondary Data Evaluation Value

As has been described above, according to the recording method of the embodiment, data is recorded with a predetermined pattern for forming edge portions between pits and lands at a plurality of predetermined positions on the disk D16, which is a ROM disk, and the edge portions are irradiated with a laser beam of high output power to induce edge shifts, thereby additionally recording secondary data different from primary data recorded as combinations of pits and lands.

The data on the disk 100, on which the above-described secondary data is recorded, is played back by the playback apparatus. By determining, on the basis of the playback result, whether a data pattern at the above-described predetermined positions corresponding to the above-described predetermined pattern is obtained, it is possible to detect the secondary data values “0” and “1”, i.e., to play back the secondary data.

As has been described above, hereinafter, the primary data recording disk D16 on which the secondary data (identification information) has been recorded is referred to as the disk 100.

The playback apparatus detects the values “0” and “1” of a signal read from the disk D100 with timing determined by the playback clock. That is, when a portion in which the secondary data is additionally recorded by inducing an edge shift is played back, this portion is detected as a shift in units of 1 T in accordance with the playback clock.

However, when the signal read from the disk 100 is observed in units of time less than the playback clock, the amounts of shift in portions in which edge shifts have been induced show a certain degree of fluctuation, depending on, for example, the characteristics of each disk D16 (disk 100) and the dispersion and fluctuation of the recording accuracy of the recording apparatus 50.

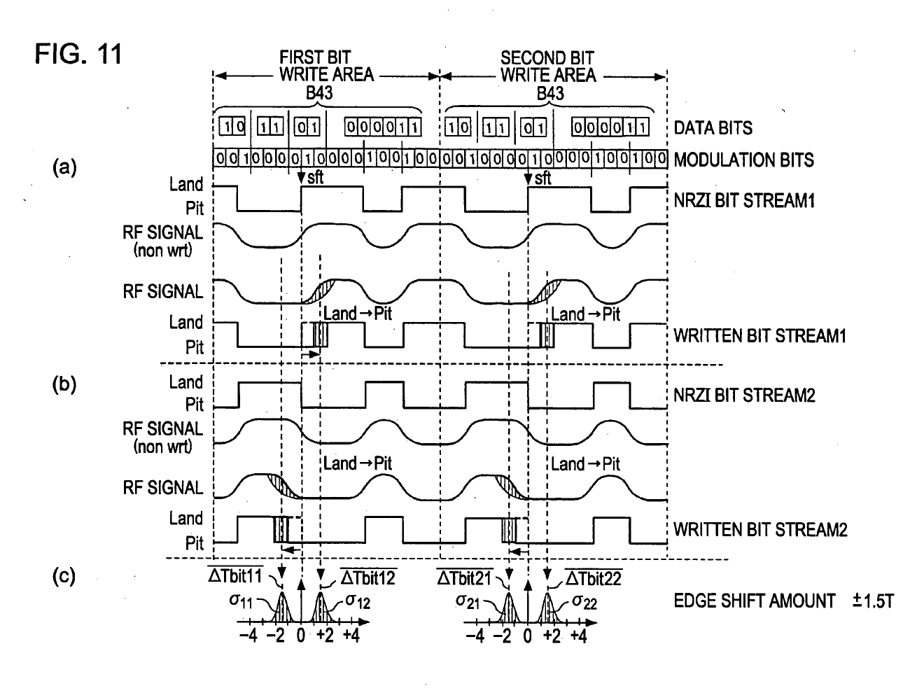

FIG. 11 is a schematic diagram showing fluctuation in shift amounts in each type of edge-shifted portion.

FIG. 11 shows the value of data bits stored in the first bit write area and the second bit write area in the ID bit write area in each frame and the value of modulation bits obtained by RLL-(1,7)-PP modulating the data bits. In this case, the data value stored in each bit write area is B43.

In FIG. 11, the case in which the amount of edge shift is 1.5 T is described by way of example.

With continued reference to FIG. 11, portion (a) shows the recording waveform and the RF signal waveform (non wrt) of NRZI bit stream 1 obtained in accordance with the stored value B43 and therebelow shows the RF signal waveform and the recording waveform (written bit stream 1) obtained by inducing an edge shift.

Portion (b) shows the recording waveform and the RF signal waveform (non wrt) of NRZI bit stream 2 obtained in accordance with the stored value B43 and therebelow shows the RF signal waveform and the recording waveform (written bit stream 2) obtained by inducing an edge shift.

Each of the waveforms, especially the RF signal waveforms and the recording waveforms (written bit streams) obtained by inducing edge shifts, which are shown in portions (a) and (b) of FIG. 11, is generated by placing waveforms obtained under the same condition in each ID bit write area in frames on the disk 100 on top of one another. Specifically, each of the waveforms in the first bit write area shown in portion (a) of FIG. 11 is generated by placing all the waveforms in the first bit write areas, among the first bit write areas in the frames, having the polarity of NRZI bit stream 1 on top of one another. Each of the waveforms in the second bit write area is generated by placing all the waveforms in the second bit write areas, among the second bit write areas in the frames, having the polarity of NRZI bit stream 1 on top of one another.

Similarly, each of the waveforms in the first bit write area shown in portion (b) of FIG. 11 is generated by placing all the waveforms in the first bit write areas, among the first bit write areas in the frames, having the polarity of NRZI bit stream 2 on top of one another. Each of the waveforms in the second bit write area is generated by placing all the waveforms in the second bit write areas, among the second bit write areas in the frames, having the polarity of NRZI bit stream 2 on top of one another.

Portion (c) of FIG. 11 shows the distribution of edge shift amounts categorized with respect to four conditions: the first bit write area, the second bit write area, and the polarities of NRZI.

As shown in FIG. 11, when the RF signal waveforms in the edge-shifted portions are placed on top of one another, these waveforms do not coincide with one another and show a certain degree of fluctuation.

Such fluctuation is known to cause communication errors and recording errors in the fields of signal communication technology and signal recording technology. To quantify the fluctuation as an evaluation index for the signal quality, an evaluation method is defined according to the communication system or the recording system.

In the embodiment, an evaluation index is defined for evaluating the recorded signal quality of secondary data (identification information) recorded by inducing edge shifts.

In the field of optical disk recording media, an evaluation value referred to as a jitter has been calculated with respect to fluctuation in the time domain, which serves as an index for evaluating the recorded signal quality. In the embodiment, an evaluation index for evaluating the recorded signal quality of secondary data recorded by inducing edge shifts is defined on the basis of such a jitter with respect to fluctuation in the time domain.

Referring back to FIG. 11, fluctuation of the signal waveforms in the edge-shifted portions will be examined.

As can be understood with reference to FIG. 11, according to the recording method of the embodiment, the edge shift direction in each bit write area is opposite, depending on the polarity of NRZI. More specifically, since an edge shift in this case is induced by making a land into a pit, for example, a shift is induced in the positive direction with respect to the edge-to-be-shifted portion sft in the case of the polarity of NRZI bit stream 1 in the first bit write area. In contrast, in the case of the polarity of NRZI bit stream 2 in the first bit write area, an edge is shifted in the negative direction with respect to the edge-to-be-shifted portion sft. Accordingly, the edge shift directions in both cases are opposite to each other. This also applies to the second bit write area.

When the edge shift direction is different, so are the fluctuation characteristics of the signal waveforms in each edge-shifted portion. As is clear from the comparison of portion (a) and portion (b) of FIG. 11, the fact that the fluctuation characteristics are different due to the different edge shift direction is conceivably influenced by whether the shifted portion becomes a land or a pit.

It is also conceivable that the fluctuation characteristics of the signal waveforms in the edge-shifted portions differ in each of the first and second bit write areas. It is thus conceivable that the edge shift amounts sampled in the bit write areas have a different distribution in each first bit write area and each second bit write area.

Therefore, there are a total of four distributions with respect to the four conditions: the first bit write area, the second bit write area, and the polarities of NRZI (see portion (c) of FIG. 11).

The amount of edge shift in the first bit write area with the polarity of NRZI bit stream 1 is denoted by ΔTbit11, and the amount of edge shift in the first bit write area with the polarity of NRZI bit stream 2 is denoted by ΔTbit12. In addition, the amount of edge shift in the second bit write area with the polarity of NRZI bit stream 1 is denoted by ΔTbit21, and the amount of edge shift in the second bit write area with the polarity of NRZI bit stream 2 is denoted by ΔTbit22.

For the four distributions of amounts of edge shift, averages thereof (ΔTbit11, ΔTbit12, ΔTbit21, and ΔTbit22) and standard deviations thereof (σ₁₁, σ₁₂, σ₂₁, and σ₂₂) are calculated.

Then, for the four distributions of amounts of edge shift, jitter components J₁₁, J₁₂, J₂₁, and J₂₂, which are jitters in these distributions, are calculated using the following equations (1):

$$\begin{matrix}{J}_{11} = \frac{{σ}_{11}}{2 \times ( \overline{Δ Tbit 11} - 0.5 T )} & {J}_{12} = \frac{{σ}_{12}}{2 \times ( \overline{Δ Tbit 12} - 0.5 T )} \\ {J}_{21} = \frac{{σ}_{21}}{2 \times ( \overline{Δ Tbit 21} - 0.5 T )} & {J}_{22} = \frac{{σ}_{22}}{2 \times ( \overline{Δ Tbit 22} - 0.5 T )}\end{matrix} \qquad ( 1 )$$

On the basis of the jitter components J₁₁, J₁₂, J₂₁, and J₂₂, an aggregate evaluation index (aggregate jitter JA) for the recording quality of secondary data recorded by inducing edge shifts on the disk 100 is calculated using the following equation (2):

$$JA = \sqrt{\frac{{J}_{11}^{2} + {J}_{12}^{2} + {J}_{21}^{2} + {J}_{22}^{2}}{4}} \qquad ( 2 )$$

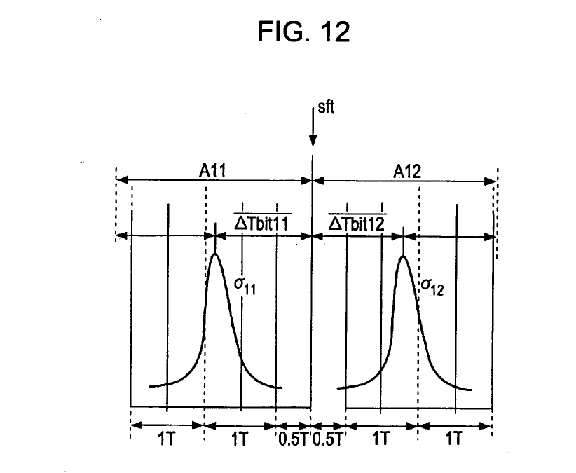

Referring now to FIG. 12, the concept of jitter calculated as above according to the embodiment will be described.

FIG. 12 shows only the distribution of edge shift amounts (ΔTbit11) in the first bit write area with the polarity of NRZI bit stream 1 and the distribution of edge shift amounts (ΔTbit12) in the first bit write area with the polarity of NRZI bit stream 2, which are shown in portion (c) of FIG. 11.

As shown in FIG. 12, the amount of shift at the peak of frequency of each distribution is expressed as the average of shift amounts (ΔTbit11 and ΔTbit12). That is, in the distribution of edge shift amounts (ΔTbit11) in the first bit write area with the polarity of NRZI bit stream 1, the average ΔTbit11 indicates the amount of shift at the peak of frequency. Similarly, in the distribution of edge shift amounts (ΔTbit12) in the first bit write area with the polarity of NRZI bit stream 2, the average ΔTbit12 indicates the amount of shift at the peak of frequency.

Each standard deviation σ shows the spread of each distribution.

On the basis of FIG. 12, the jitter components J calculated by equations (1) will be examined. As has been done in the past to calculate a jitter of primary data, a jitter is basically calculated by dividing the standard deviation a by the doubled average.

With such a known jitter calculation equation, in FIG. 12, an index reflecting the spread of the distribution within a range from the edge-to-be-shifted portion sft to the doubled average (A11 and A12 in FIG. 12) is calculated.

When the known jitter calculation equation is applied as it is, calculation is performed on the basis of the range including the edge-to-be-shifted portion sft, that is, a portion in which the amount of shift is zero. When it is desirable to calculate, as in the embodiment, an evaluation value for evaluating the recording quality of secondary data recorded by inducing edge shifts, it is difficult to obtain an accurate evaluation value.

The secondary data recorded by inducing edge shifts will be examined. At the time of playback, an edge shift can be detected when the amount of edge shift is equal to 1 T. Specifically, the playback apparatus performs a binary decision by slicing a playback signal in units of playback clocks. With such a binary decision, it is possible to detect an edge shift when the amount of edge shift is greater than or equal to the minimum amount of shift that can be detected as an edge shift (hereinafter referred to as the minimum shift amount).

As has been described above, according to the known concept of jitter, the reference range is a range from the edge-to-be-shifted portion sft, that is, the portion in which the shift amount is zero. As a result, even a portion where no edge shift is actually detected is included in the reference range for calculating a jitter. Therefore, a jitter calculated by the known jitter calculation equation is insufficient to serve as an index for accurately evaluating the recording quality of secondary data recorded by inducing edge shifts.

Generally, with a binary decision, an edge shift of 1 T is detected when an edge is shifted by 0.5 T or more. In order to evaluate the recording quality of secondary data recorded by inducing edge shifts, as in the embodiment, it is necessary for the reference range to include only a range of 0.5 T or more with which an edge shift is detectable.

To this end, as is shown by equations (1), with regard to the average (ΔTbit11, ΔTbit12, ΔTbit21, and ΔTbit22) of each distribution, the standard deviation (σ₁₁, σ₁₂, σ₁₃, and σ₁₄) of each distribution is divided by 2×(average−0.5 T), which serves as the reference range, thereby calculating each jitter component J (J₁₁, J₁₂, J₂₁, and J₂₂).

According to the jitter components J of the embodiment, a portion where no edge shift is detected is not included in the reference range. It is thus possible to obtain an evaluation index for accurately evaluating the recording quality of secondary data recorded by inducing edge shifts.

According to the above-described embodiment, each jitter component J (J₁₁, J₁₂, J₂₁, and J₂₂) is obtained independently in each distribution of edge shift amounts categorized with respect to their associated bit write areas and edge shift directions. Then, using equation (2), a value equivalent to the average of absolute values of these jitter components J is calculated as the aggregate jitter JA.

Even when the characteristics of the distribution of the edge shift amounts are different depending on the edge shift direction and the type of bit write area, the more accurate aggregate jitter JA can be calculated.

Although the minimum shift amount has been set to a general value of 0.5 T, it is not limited thereto and may be set to a value with which an edge shift is detectable.

5. Evaluation Apparatus

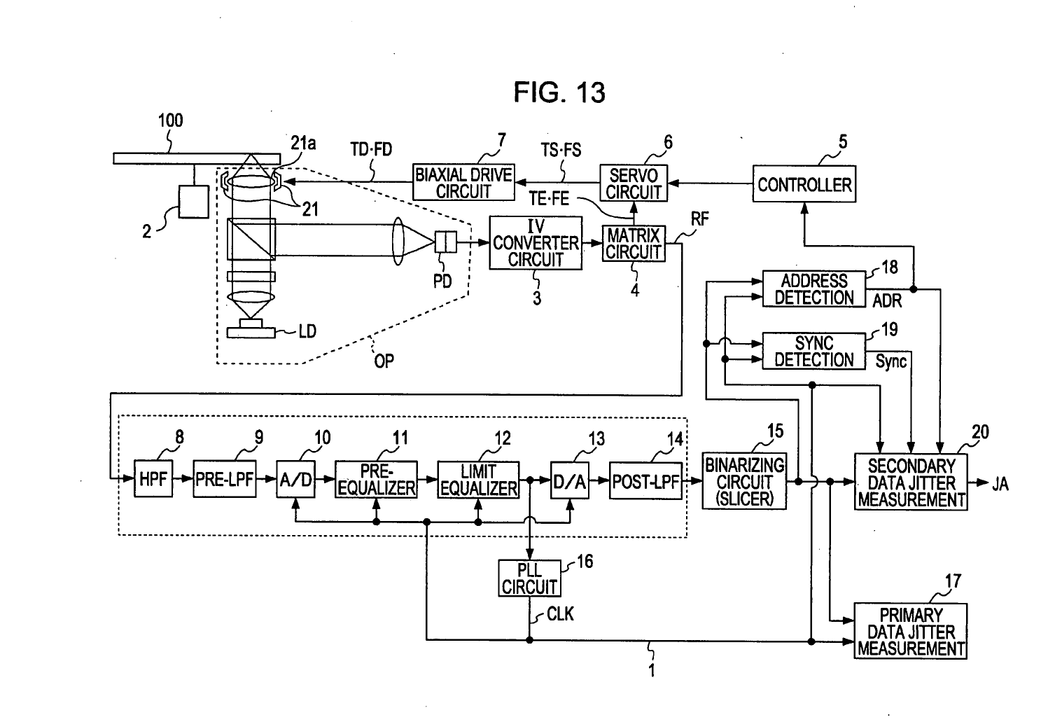

FIG. 13 is a block diagram showing the internal configuration of an evaluation apparatus 1 for actually calculating an evaluation value according to the embodiment, which has been described above, on the basis of a playback signal from the disk 100.

In the evaluation apparatus 1, the disk 100 is placed on a turntable (not shown) and rotated by a spindle motor 2 in accordance with a predetermined rotating and driving method. An optical pickup OP (shown in FIG. 13) reads a recorded signal (primary data) from the rotated disk 100.

The optical pickup OP includes a laser diode LD serving as the laser source in FIG. 13, an objective lens 21a for gathering a laser beam and irradiating a recording surface of the disk 100, and a photodetector PD for detecting the reflected light from the disk 100 due to the laser irradiation.

The optical pickup OP further includes a biaxial mechanism 21 for movably holding the objective lens 21a in the focusing and tracking directions. The biaxial mechanism 21 drives the objective lens 21a in the focusing and tracking directions on the basis of a focusing drive signal FD and a tracking drive signal TD from a biaxial drive circuit 7 described below.

For the sake of confirmation, the laser beam irradiated on the disk 100 by the evaluation apparatus 1 has recording power. Although not shown in FIG. 13, the laser power of the laser diode LD in this case is subjected to so-called APC control in which the laser output level is monitored by, for example, a monitor detector included in the optical pickup OP so that the laser power is maintained at the playback power level.

In this case, the laser wavelength λ is 405 nm, and the numerical aperture (NA) of the objective lens 52a is 0.85.

The reflected light information detected by the photodetector PD in the optical pickup OP is converted by an IV converter circuit 3 into an electrical signal, and the electrical signal is supplied to a matrix circuit 4. On the basis of the reflected light information from the IV converter circuit 3, the matrix circuit 4 generates a playback signal RF, a tracking error signal TE, and a focusing error signal FE.

A servo circuit 6 has the similar configuration as that of the servo circuit 55 shown in FIG. 8. On the basis of the tracking error signal TE and the focusing error signal FE from the matrix circuit 4, the servo circuit 6 generates a tracking servo signal TS and a focusing servo signal FS. The servo circuit 6 supplies the tracking servo signal TS and the focusing servo signal FS to the biaxial drive circuit 7.

On the basis of the tracking servo signal TS and the focusing servo signal FS, the biaxial drive circuit 7 generates the tracking drive signal TD and the focusing drive signal FD and supplies these signals TS and FD to a tracking coil and a focusing coil.

Also in this case, the photodetector PD, the IV converter circuit 3, and the matrix circuit 4 form a tracking servo loop, and the servo circuit 6, the biaxial drive circuit 7, and the biaxial mechanism 21 form a focusing servo loop. With the tracking servo loop and the focusing servo loop, control is performed so that the spot of a laser beam irradiated on the disk 100 traces a pit sequence (recording track) formed on the disk 100 and is maintained in an appropriate focused state.

The playback signal RF generated by the matrix circuit 4 is supplied to a high pass filter (HPF) 8, and low frequency components of the playback signal RF are removed. The resultant playback signal RF is supplied to a pre-low pass filter (pre-LPF) 9. In order to prevent aliasing in sampling by an analog-to-digital (A/D) converter 10 at a subsequent stage, the pre-LPF 9 removes frequency components of the playback signal RF greater than or equal to half the sampling frequency of the A/D converter 10.

The A/D converter 10 samples the playback signal RF supplied by the pre-LPF 9 with timing determined by a clock CLK supplied by a PLL circuit 16, which will be described later.

A pre-equalizer 11 receives sampled data of the playback signal RF supplied by the A/D converter 10 and performs equalization or the like to remove intersymbol interference based on the transmission characteristics of a signal reading system including the disk 100 and the optical pickup OP. The pre-equalizer 11 is, for example, a transversal filter with tap coefficients (k, 1, 1, and k).

A limit equalizer 12 enhances high frequency components of the sampled data of the playback signal RF, which has been equalized by the pre-equalizer 11, so that intersymbol interference is not increased. The sampled data of the playback signal RF, which has been subjected to high-frequency enhancement by the limit equalizer 12, is converted by a digital-to-analog (D/A) converter 13 into an analog signal, and the analog signal is supplied to a post-LPF 14.

The sampled data of the playback signal RF, which has been subjected to high-frequency enhancement by the limit equalizer 12, is branched and supplied to the PLL circuit 16. The PLL circuit 16 generates the clock CLK on the basis of the sampled data of the playback signal RF. This clock CLK is supplied to the above-described A/D converter 10, the pre-equalizer 11, the limit equalizer 12, and the D/A converter 13. The clock CLK is also supplied as the operation clock necessary for each part, including a primary data jitter measuring circuit 17, an address detecting circuit 18, a sync detecting circuit 19, and a secondary data jitter measuring circuit 20, which will be described later, in the evaluation apparatus 1.

In order to prevent aliasing in D/A conversion by the D/A converter 13, the post-LPF 14 extracts low frequency components (baseband components) of the supplied playback signal RF and supplies the extracted frequency components to a binarizing circuit 15.

The binarizing circuit 15 functions as a slicer including, for example, a comparator. The binarizing circuit 15 slices the playback signal RF supplied by the post-LPF 14 on the basis of a predetermined threshold and outputs the result as a binary signal.

This binary signal is supplied to, as shown in FIG. 13, the primary data jitter measuring circuit 17, the address detecting circuit 18, the sync detecting circuit 19, and the secondary data jitter measuring circuit 20.

The configuration of a portion enclosed by broken lines in FIG. 13 (from the HPF 8 to the post-LPF 14) is mainly for shaping the waveform to enhance the high frequency components of the playback signal RF (i.e., portions of the playback signal RF in which the mark lengths are short) without causing intersymbol interference. With this configuration, when, as in the case of the disk 100 (disk D16) of the embodiment, a signal is recorded with a relatively high recording density, a binary signal appropriate for measuring an evaluation value can be obtained.

The configuration enclosed by the broken lines is also described in Japanese Unexamined Patent Application Publication No. 2003-303474.

The sync detecting circuit 19 detects a sync portion inserted in each frame shown in FIG. 2 (FIG. 3) on the basis of the supplied binary signal.

A frame sync signal is supplied to each necessary part including the address detecting circuit 18. Particularly in this case, address information ADR is supplied also to the secondary data jitter measuring circuit 20.

The address detecting circuit 18 detects the address information ADR on the basis of the frame sync signal and the binary signal. The detected address information ADR is supplied to a controller 5 that performs the overall control of the evaluation apparatus 1. The address information ADR is also supplied to the secondary data jitter measuring circuit 20.

The primary data jitter measuring circuit 17 measures a jitter of primary data on the basis of the binary signal from the binarizing circuit 15 and the clock CLK. Although not shown in FIG. 13, the measured value is supplied to the controller 5.

On the basis of the binary signal, the clock CLK, the frame sync signal (sync), and the address information ADR, the secondary data jitter measuring circuit 20 measures a jitter (aggregate jitter JA) for evaluating secondary data recorded by inducing edge shifts on the disk 100. Although not shown in FIG. 13, the aggregate jitter JA measured by the secondary data jitter measuring circuit 20 is supplied to the controller 5.

The jitter measuring operation of the secondary data jitter measuring circuit 20 will be described later.

The controller 5 includes, for example, a microcomputer and performs the overall control of the evaluation apparatus 1.

For example, in response to an operation input from an operation unit (not shown), the controller 5 controls each necessary part so that the reading operation targeted at a designated address can be performed. In other words, by designating a target address to the servo circuit 6, the servo circuit 6 performs an access operation of the optical pickup OP targeted at the target address.

Although not shown in FIG. 13, the controller 5 includes a display unit including a display device, such as a liquid crystal display (LCD). The controller 5 can display various types of information using the display unit.

In the above-described case, the configuration for shaping the waveform, which is enclosed by the broken lines, is provided to calculate a jitter of the signal recorded on the disk 100 having a relatively high recording density. However, not all the parts of the configuration are necessary to calculate a jitter on a disk, such as a compact disc (CD), which does not have a high recording density.

Although the primary data jitter measuring circuit 17 is provided in the above-described case to measure a jitter of the primary data recorded on the disk 100 on the basis of the binary signal, the primary data jitter measuring circuit 17 may be omitted.

6. Evaluation Value Measuring Operation

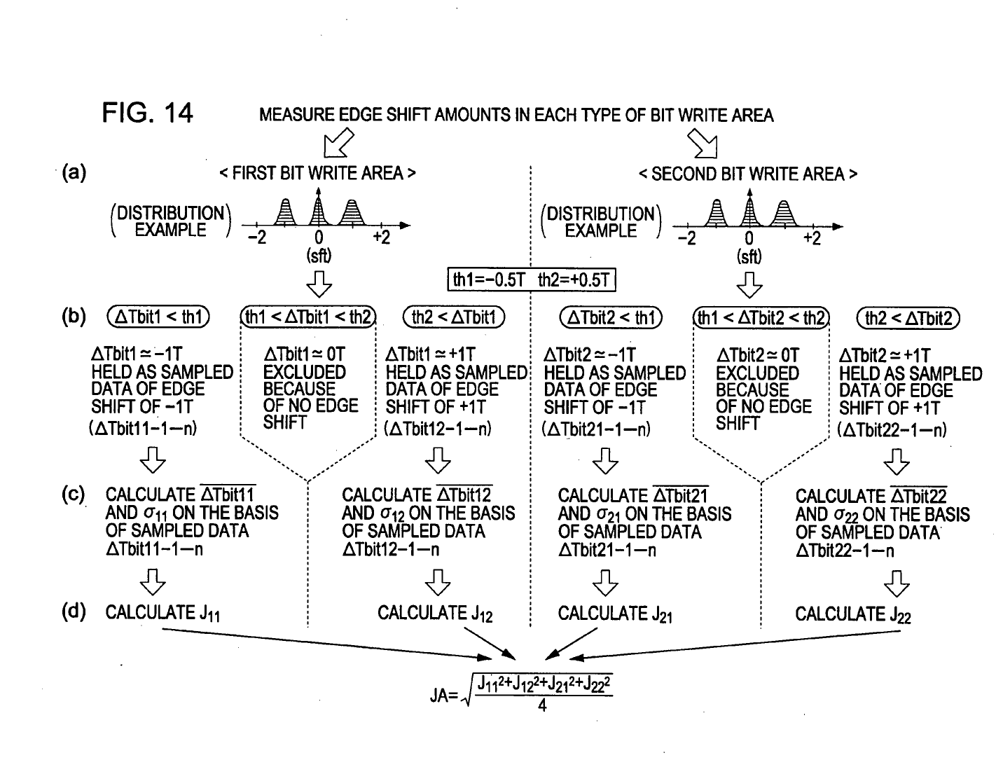

FIG. 14 is a chart schematically illustrating the operation performed by the secondary data jitter measuring circuit 20 shown in FIG. 13.

As shown in portion (a) of FIG. 14, the secondary data jitter measuring circuit 20 measures the amounts of edge shift in each type of bit write area. Specifically, the secondary data jitter measuring circuit 20 holds the amounts of edge shift measured in the first bit write areas as measured values in the first bit write areas and holds the amounts of edge shift measured in the second bit write areas as measured values in the second bit write areas. In this manner, the sub-data jitter measuring circuit 20 measures the amounts of edge shift in each type of bit write area.

As shown by distribution examples in portion (a) of FIG. 14, the amounts of edge shift in each type of bit write area are distributed over three peaks: one distribution with a peak at around “+1”; another distribution with a peak at around “−1”; and another distribution with a peak at around “0”.

The amounts of edge shift are distributed with a peak at around “+1” and with another peak at around “−1” because, as has been described with reference to FIG. 11, even in the same bit write area, the edge shift direction is different (positive and negative directions) depending on the polarity of NRZI. The amounts of edge shift are also distributed with a peak at around “0” because there is a bit write area in which the identification information value “0” is recorded, that is, no edge shift is induced.

After the amounts of edge shift in each type of bit write area have been measured as described above, the measured values, namely, the edge shift amounts ΔTbit1 measured in the first bit write areas and the edge shift amounts ΔTbit2 measured in the second bit write areas, are categorized on the basis of predetermined thresholds th1 and th2.

As has been described above, even in the same type of bit write area, there are two modes of edge shift depending on the polarity of NRZI: one being a shift in the positive direction and the other being a shift in the negative direction. Depending on the mode, the distribution characteristics are different. Therefore, the measured values are categorized with respect to the positive and negative shift directions.

In this case, categorizing of the measured values with respect to the positive and negative shift directions is performed on the basis of the threshold th1=−0.5 T and the threshold th2=+0.5 T shown in portion (a) of FIG. 14. That is, on the assumption that the amount of edge shift in the negative direction is less than −0.5 T, when the measured value ΔTbit (ΔTbit1 and ΔTbit2) is less than the threshold th1, it is held as sampled data of an edge shift (shift of −1 T) in the negative direction.

Similarly, on the assumption that the amount of edge shift in the positive direction is greater than +0.5 T, when the measured value ΔTbit is greater than the threshold th2, it is held as sampled data of an edge shift (shift of +1 T) in the positive direction.

When the measured value ΔTbit is greater than the threshold th1 and less than the threshold th2, the measured value ΔTbit is held as sampled data of a shift of 0 T, i.e., sampled data of no edge shift by which the identification information value “0” is recorded. This measured value ΔTbit is excluded from calculating a jitter, which will be described below.

In this case, the measured values ΔTbit1 in the first bit write areas, which are less than the threshold th1 and thus regarded as negative-direction shifts, are referred to as sampled data ΔTbit11−1−n, which are shown in portion (b) of FIG. 14.

Also, the measured values ΔTbit1 that are greater than the threshold th2 and thus regarded as positive-direction shifts are referred to as sampled data ΔTbit12−1−n.

In addition, the measured values ΔTbit2 in the second bit write areas, which are less than the threshold th1 and thus regarded as negative-direction shifts, are referred to as sampled data ΔTbit21−1−n. Also, the measured values ΔTbit2 that are greater than the threshold th2 and thus regarded as positive-direction shifts are referred to as sampled data ΔTbit22−1−n.

The number of pieces of sampled data is similarly designated by “1−n”. However, “n” in this case simply represents a variable, and not all the sampled data have the same number of data.

In the description of the operation shown in portions (a) and (b) of FIG. 14, for the sake of convenience, after the amounts of edge shift in each type of bit write area have been measured, these measured values ΔTbit are categorized on the basis of the thresholds th1 and th2 (categorized into groups of shift directions and no edge shift). In actual operation, however, it is preferable that, after the amount of edge shift at one position is measured, this measured value be categorized on the basis of the thresholds th1 and th2. In this way, the efficiency is increased, thereby reducing the measurement time.

After the measured values ΔTbit are categorized with respect to the first and second bit write areas and then categorized with respect to their associated shift directions, the average and the standard deviation of each categorized group of the measured values ΔTbit are calculated, as shown in portion (c) of FIG. 14.

Specifically, for the sampled data ΔTbit11−1−n categorized as negative-direction shifts in the first bit write areas, the average ΔTbit11 and the standard deviation σ₁₁ are calculated.

Also, for the sampled data ΔTbit12−1−n categorized as positive-direction shifts in the first bit write areas, the average ΔTbit12 and the standard deviation σ₁₂ are calculated.

Similarly, for the sampled data ΔTbit21−1−n categorized as negative-direction shifts in the second bit write areas, the average ΔTbit21 and the standard deviation σ₂₁ are calculated. For the sampled data ΔTbit22−1−n categorized as positive-direction shifts in the second bit write areas, the average ΔTbit22 and the standard deviation σ₂₂ are calculated.

Then, as shown in portion (d) of FIG. 14, calculation using equations (1) is performed on the basis of the calculated ΔTbit11, ΔTbit12, ΔTbit21, and ΔTbit22, the standard deviations σ₁₁, σ₁₂, σ₂₁, and σ₂₂, and the predetermined minimum shift amount (0.5 T), thereby calculating jitter components J₁₁, J₁₂, J₂₁, and J₂₂.

After the jitter components J₁₁, J₁₂, J₂₁, and J₂₂ have been calculated, the aggregate jitter JA corresponding to the average of absolute values of J₁₁, J₁₂, J₂₁, and J₂₂ is calculated using equation (2).

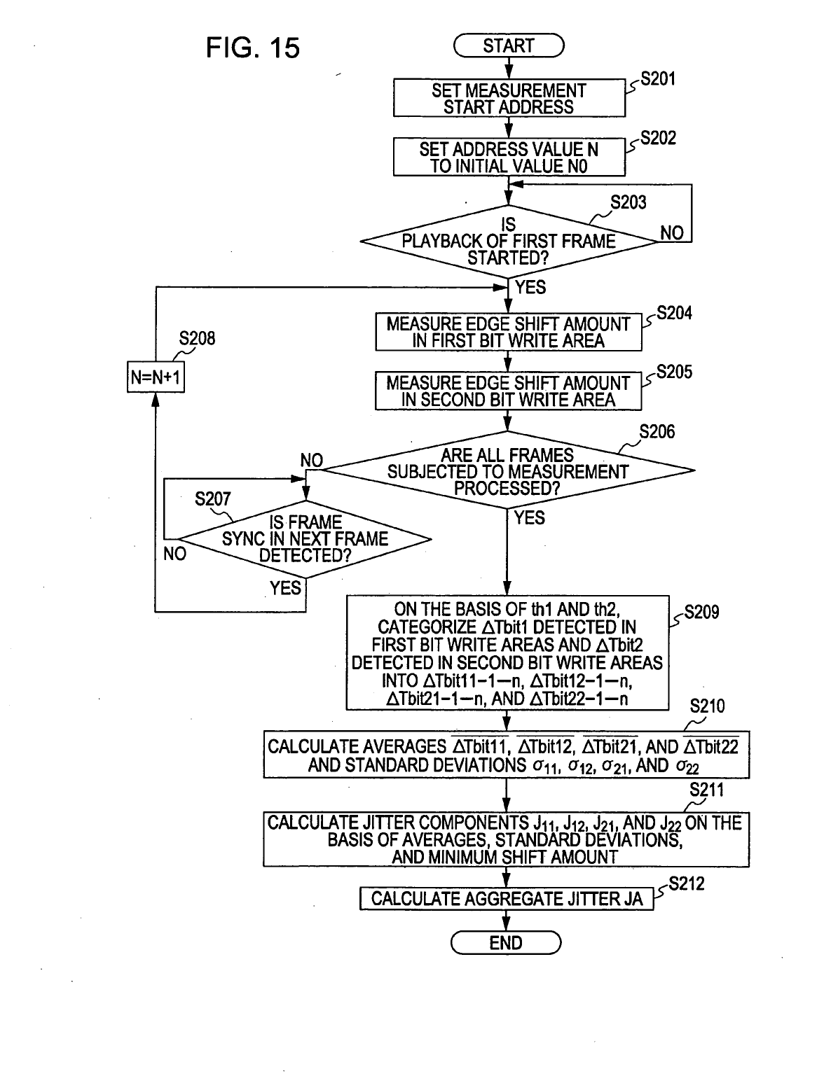

Referring now to the flowchart of FIG. 15, the operation performed in the evaluation apparatus 1 in association with the above-described jitter measuring operation will be described.

In FIG. 15, it is assumed that the disk 100 has already been loaded into the evaluation apparatus 1.

In step S201, the controller 5 shown in FIG. 13 sets the measurement start address. The measurement start address is the address of the first frame in an area on the disk 100 allocated in advance for recording the identification information. In response to, for example, the loading of the disk 100, the controller 5 designates the measurement start address to the servo circuit 6. In response to this, the seeking operation in which the measurement start address serves as the target address is performed.

In step S202, the address value N is set to the initial value NO.

The operation in step S202 is performed by the secondary data jitter measuring circuit 20 to set the internal counter value to the initial value NO in order to count the number of frames in which amounts of edge shift are measured, which will be described below.

In step S203, the secondary data jitter measuring circuit 20 waits for the start of playback of the first frame. Specifically, subsequent to the seeking operation in accordance with the setting of the measurement start address in step S201, the secondary data jitter measuring circuit 20 waits for the start of playback of the first frame including an identification information recording area on the disk 100. The start of playback of the first frame can be detected in response to the supply of the frame sync signal from the sync detecting circuit 19.

In step S204, the amount of edge shift in the first bit write area is measured. Specifically, the secondary data jitter measuring circuit 20 measures the amount of edge shift in the first bit write area on the basis of the binary signal supplied by the binarizing circuit 15 and the clock CLK.

The amount of edge shift can be measured by measuring, for example, how far the edge position of the edge-to-be-shifted portion sft has moved.

According to the recording method of the embodiment, as can be understood from the above description, the position of the edge-to-be-shifted portion sft is defined in advance by the format. For example, it is known in advance at which clock (counting from the frame sync) the position of the edge-to-be-shifted portion sft occurs. Therefore, the counting of the clock starts from the frame sync, and edge timing of a binary signal obtained within a few clocks prior and subsequent to the predetermined edge-to-be-shifted portion sft in the first bit write area is detected. Since, in this case, it is assumed that an edge shift of 1 T is induced, the edge timing is detected within an effective interval of two to three clocks prior and subsequent to the edge-to-be-shifted portion sft.

Then, the difference between the edge timing detected in this manner and the timing of the edge-to-be-shifted portion sft defined by the format is calculated, thereby measuring the amount of edge shift.

In this case, when the edge position is detected in units of clocks CLK, the measured edge shift amount is also in units of clocks CLK, and sampled data thereof may not be suitable for measuring a jitter. Therefore, the edge position is detected on the basis of a clock with a period sufficiently shorter than the clock CLK.

In step S205, the amount of edge shift in the second bit write area is measured.

In the second bit write area, it is known in advance at which clock (counting from the frame sync) the position of the edge-to-be-shifted portion sft occurs. Edge timing of a binary signal obtained within a few clocks prior and subsequent to the predetermined edge-to-be-shifted portion sft is detected. The difference between the detected edge timing and the timing of the edge-to-be-shifted portion sft defined by the format is calculated, thereby measuring the amount of edge shift.

In step S206, it is determined whether all the frames subjected to measurement have been processed. Specifically, the secondary data jitter measuring circuit 20 determines whether the measurement has been done in all the frames allocated to record the identification information on the disk 100. The determination is performed by the sub-data jitter measuring circuit 20 determining whether the counter value, which has been set to the initial value NO in step S202, has reached a predetermined value. When the determination is negative meaning that the counter value has not reached the predetermined value, in step S207, the secondary data jitter measuring circuit 20 waits for detection of frame sync in the next frame. That is, the secondary data jitter measuring circuit 20 waits for a new frame sync signal to be supplied by the sync detecting circuit 19. When the frame sync in the next frame is detected, in step S208, the address value N is incremented by one (step S111), and the operation returns to step S204. Accordingly, the amounts of edge shift in each bit write area in all the frames allocated to record the identification information are measured.

When it is determined in step S206 that the counter value has reached the predetermined value and that all the frames subjected to measurement have been processed, in step S209, the edge shift amounts (measured values) ΔTbit1 measured in the first bit write areas and the edge shift amounts (measured values) ΔTbit2 measured in the second bit write areas are categorized on the basis of the thresholds th1 and th2 into the sampled data ΔTbit11−1−n and ΔTbit12−1−n and the sampled data ΔTbit21−1−n and ΔTbit22−1−n, respectively.

That is, the secondary data jitter measuring circuit 20 categorizes each of the measured values ΔTbit1 measured in the first bit write areas on the basis of the set thresholds th1 and th2, with respect to the following conditions: “ΔTbit1<threshold th1”, “threshold th1<ΔTbit1<threshold th2”, and “threshold th2<ΔTbit1”.

Among the measured values ΔTbit1, the measured values ΔTbit1 falling under the conditions “ΔTbit1<threshold th1” and “threshold th2<ΔTbit1” are held as sampled data ΔTbit11−1−n of negative-direction edge shifts and sampled data ΔTbit12−1−n of positive-direction edge shifts, respectively.

The measured values ΔTbit1 falling under the condition “threshold th1<ΔTbit1<threshold th2” are excluded from calculating a jitter, since these measured values ΔTbit1 are regarded as having no edge shifts.

Similarly, the edge shift amounts (measured values) ΔTbit2 measured in the second bit write areas are categorized with respect to the following conditions: “ΔTbit2<threshold th1”, “threshold th1<ΔTbit2<threshold th2”, and “threshold th2<ΔTbit2”.

Among the measured values ΔTbit2, the measured values ΔTbit2 falling under the conditions “ΔTbit2<threshold th1” and “threshold th2<ΔTbit2” are held as sampled data ΔTbit21−1−n of negative-direction edge shifts and sampled data ΔTbit21−1−n of positive-direction edge shifts, respectively. Also in this case, the measured values ΔTbit2 falling under the condition “threshold th1<ΔTbit2<threshold th2” are excluded from calculating a jitter.

It has been described that, after the amounts of edge shift in each type of bit write area have been measured, these measured values ΔTbit are categorized on the basis of the thresholds th1 and th2. In actual operation, however, it is preferable that, after the amount of edge shift at one position is measured, this measured value be categorized on the basis of the thresholds th1 and th2. In this way, the efficiency is increased, thereby reducing the measurement time.

In other words, it is preferable that the categorizing with respect to the positive and negative shift directions on the basis of the thresholds th1 and th2, which is performed in step S209, be simultaneously performed in steps S204 and S205 in which the measurement is performed for each bit write area.

In step S210, the averages ΔTbit11, ΔTbit12, ΔTbit21, and ΔTbit22 and the standard deviations σ₁₁, σ₁₂, σ₂₁, and σ₂₂ are calculated.

Specifically, the secondary data jitter measuring circuit 20 calculates the average ΔTbit11 and the standard deviation σ₁₁ of the sampled data ΔTbit11−1−n categorized as the negative-direction shifts in the first bit write areas. Also, the secondary data jitter measuring circuit 20 calculates the average ΔTbit12 and the standard deviation σ₁₂ of the of the sampled data ΔTbit12−1−n categorized as the positive-direction shifts in the first bit write areas.

Similarly, the secondary data jitter measuring circuit 20 calculates the average ΔTbit21 and the standard deviation σ₂₁ of the sampled data ΔTbit21−1−n categorized as the negative-direction shifts in the second bit write areas. Also, the secondary data jitter measuring circuit 20 calculates the average ΔTbit22 and the standard deviation σ₂₂ of the of the sampled data ΔTbit22−1−n categorized as the positive-direction shifts in the second bit write areas.

Then, calculation using equations (1) is performed on the basis of the calculated ΔTbit11, ΔTbit12, ΔTbit21, and ΔTbit22, the standard deviations σ₁₁, σ₁₂, σ₂₁, and σ₂₂, and the predetermined minimum shift amount (0.5 T), thereby calculating jitter components J₁₁, J₁₂, J₂₁, and J₂₂ In step S212, the aggregate jitter JA is calculated using equation (2) on the basis of the jitter components J₁₁, J₁₂, J₂₁, and J₂₂.

Although not shown in FIG. 15, information on the aggregate jitter JA calculated by the secondary data jitter measuring circuit 20 in this manner is actually supplied to the controller 5 to be displayed on the display unit.

7. Optical Disk Manufacturing Method Using Evaluation Apparatus

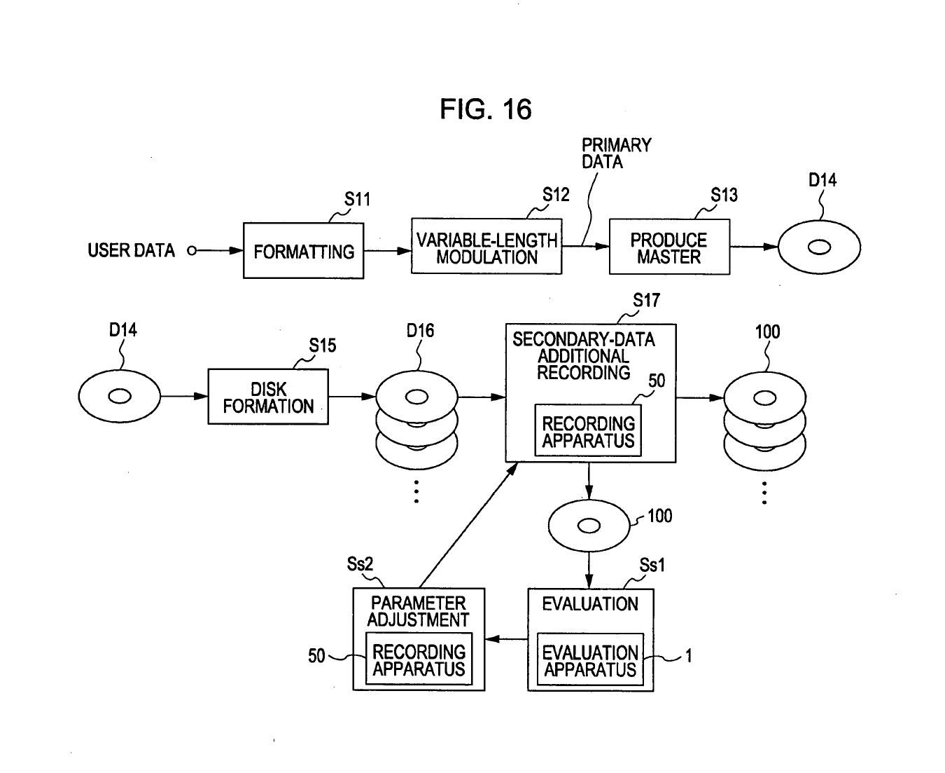

Referring now to FIG. 16, a method of manufacturing the disk 100 using the evaluation apparatus 1 according to the embodiment will be described.

In FIG. 16, the steps up to disk formation step S15 are for manufacturing the primary data recording disk D16 on which only the primary data is recorded as combinations of pits and lands.

At first, in formatting step S11, content data (user data) that should be recorded on the primary data recording disk D16 is converted into a sequence of format data in conformity to a predetermined standard. That is, in the embodiment, conversion is performed so as to generate a data sequence in conformity to the “Blu-Ray Discs” standard shown in FIGS. 2 and 3. In actual operation, an error detecting code and an error correcting code are added and interleaved in the user data. The formatting step is performed using, for example, a computer.

In variable-length modulation step S12, the data sequence generated in formatting step S11 is subjected to variable-length modulation. In the embodiment, the data sequence is subjected to RLL (1,7) PP modulation and NRZI modulation, thereby generating a pattern of “0” and “1”, which serves as primary data to be recorded as combinations of pits and lands on the primary data recording disk D16 (disk 100).

Subsequently, master producing step S13 is performed. This master producing step S13 is performed using a mastering apparatus.

In master producing step S13, a glass master is coated with a photoresist. While being rotated, the glass master coated with the photoresist is irradiated with a laser beam in accordance with the primary data generated in the above-described variable-length modulation step S12, thereby forming an uneven pattern, namely, pits and lands, along the recording track.

The resist on which pits and lands are formed is developed and fixed on the glass master. The surface of the master is electrolytically plated to generate a metal master D14 shown in FIG. 16.

Using the metal master D14 produced in this manner, disk formation step S15 is performed.

In disk formation step S15, a stamper is fabricated on the basis of the metal master D14. The stamper is placed in a molding die, and the substrate 101 is formed of a transparent resin, such as a polycarbonate resin or an acrylic resin, using an injection molding machine. On the substrate 101, a pattern of pits and lands in accordance with the primary data generated in the previous modulation step S12 is formed along the recording track.

The reflecting layer 102 is laminated on the substrate 101 by vapor deposition or the like, and the covering layer 103 is bonded onto the reflecting layer 102. As a result, the primary data recording disk D16 on which data (primary data) is recorded as combinations of pits and lands is formed.

By the following steps, identification information serving as secondary data is additionally recorded on the primary data recording disk D16 manufactured in this manner, thereby manufacturing the disk 100 according to the embodiment.

At first, secondary-data additional recording step S17 is performed.

This secondary-data additional recording step is performed using the above-described recording apparatus 50. Since the secondary-data additional recording operation has already been described, a repeated description thereof is omitted.

In secondary-data additional recording step S17, only a few test disks are produced to serve as the disks D100 (first secondary-data recording step).

Using the test disk 100 on which the secondary data has been recorded in the above-described manner, evaluation step Ss1 shown in FIG. 16 is performed. Specifically, the test disk 100 is loaded into the evaluation apparatus 1 described above, and the aggregate jitter JA of the disk 100 is measured. Since the operation of the evaluation apparatus 1 to measure the jitter JA has already been described, a repeated description thereof is omitted.

On the basis of the aggregate jitter JA measured in this manner, parameter adjusting step Ss2 is performed. Specifically, various parameters (e.g., the recording pulse width and the laser power) of the recording apparatus 50 for recording the secondary data are adjusted so that the recording quality of secondary data can be improved.

The recording apparatus 50 for which various parameters have been adjusted performs again the above-described secondary-data additional recording step S17 to mass-produce disks 100 (second secondary-data recording step).

According to the disk manufacturing method of the embodiment, the recording parameters of the recording apparatus 50 can be adjusted on the basis of information on the aggregate jitter JA, which serves as an accurate evaluation index for evaluating the recording quality of secondary data, which is measured by the evaluation apparatus 1. In other words, the recording apparatus 50 can be reliably adjusted so as to improve the recording quality of secondary data. As a result, the disk 100 with a good secondary data recording quality can be manufactured.

8. Modifications

Modifications of the embodiment will be described.

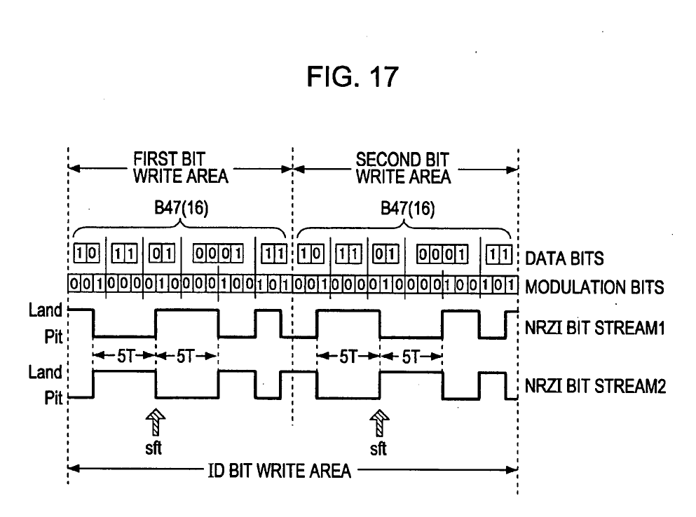

FIG. 17 is a diagram illustrating a recording method according to a first modification of the embodiment.

In the recording method of the first modification, the data value stored in the first bit write area and the second bit write area is changed from B43 to B47.

With the data value B47, as shown in FIG. 17, modulation bits in each bit write area have a value of “001000010000100101”. Also, as in the case of B43, the seventh clock from the beginning of each bit write area is the edge-to-be-shifted portion sft, which is an edge portion between a land and a pit of a predetermined length (5 T in this case).

With reference to the recording waveforms subsequent to NRZI modulation, whereas the same recording waveform has been obtained both in the first and second bit write areas in the case of B43 shown in FIG. 4, in the case of B47, recording waveforms of different polarities are obtained in the first bit write area and the second bit write area.

In the recording method of the first modification, when an edge shift is induced by making a land into a pit, as in the above description, the edge shift position in the first bit write area with the polarity of NRZI bit stream 1 shown in FIG. 17 is the eighth channel bit from the beginning, and the edge shift position in the second bit write area is the seventh channel bit from the beginning.

In the case of the polarity of NRZI bit stream 2, the edge shift position in the first bit write area is the seventh channel bit from the beginning, and the edge shift position in the second bit write area is the eighth channel bit from the beginning.

For the sake of confirmation, in the first modification, the formatting is done in the above-described formatting step S11 shown in FIG. 16 to achieve the data structure in the ID bit write area shown in FIG. 17.

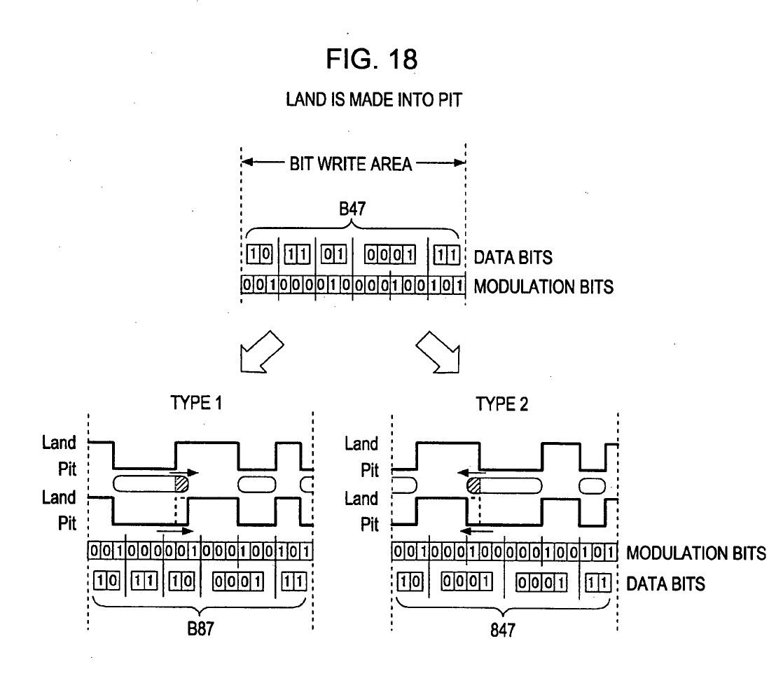

FIG. 18 shows the recording waveforms of type 1 and type 2 obtained by inducing edge shifts according to the recording method of the first modification. In FIG. 18, the case in which an edge shift of 1 T is induced by making a land into a pit is shown by way of example.

Referring to FIG. 18, type 1 shows, as can be understood with reference to FIG. 17, the recording waveform in the first bit write area with the polarity of NRZI bit stream 1 and the recording waveform in the second bit write area with the polarity of NRZI bit stream 2. Type 2 shows the recording waveform in the first bit write area with the polarity of NRZI bit stream 2 and the recording waveform in the second bit write area with the polarity of NRZI bit stream 1. That is, the only possible recording waveforms in each bit write area obtained by the recording method of the first modification are of type 1 and type 2.

As shown in FIG. 18, in the case of the recording waveform of type 1, when an edge shift of 1 T is induced by making a land into a pit, modulation bits have a value of “001000001000100101”, which can be RLL-(1,7)-PP-demodulated into data bits shown at the bottom with a value of B87 (101110000111).

In the case of the recording waveform of type 2, when an edge shift of 1 T is induced by making a land into a pit, modulation bits have a value of “001000100000100101”, which can be RLL-(1,7)-PP-demodulated into data bits shown at the bottom with a value of 847 (100001000111).

Accordingly, even with the recording method of the first modification, in association with the case in which an edge shift of 1 T is induced by making a land into a pit, modulation bits subsequent to the edge shift having a value that follows the RLL (1,7) PP modulation rule can be obtained.

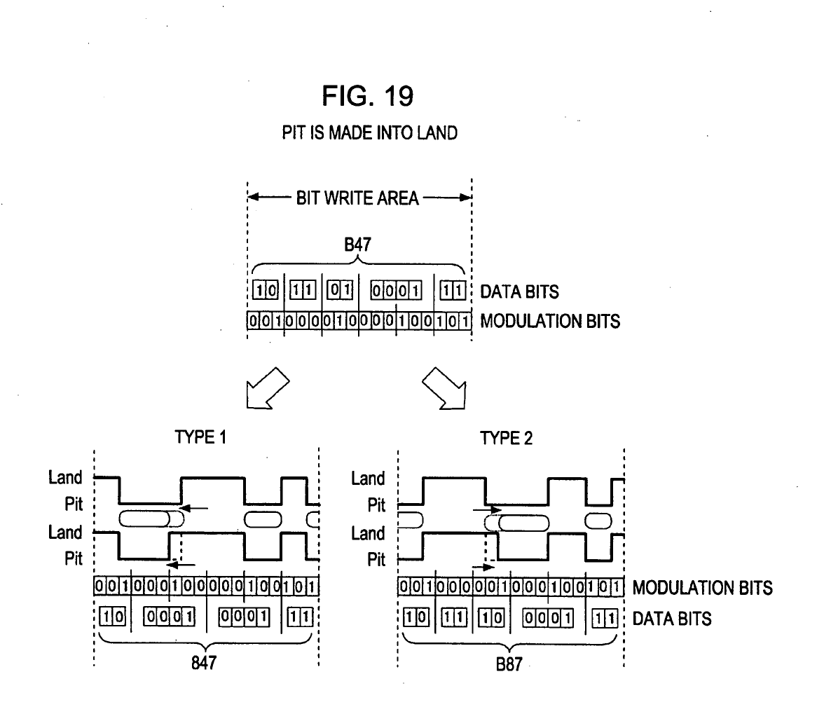

FIG. 19 shows the recording waveforms of type 1 and type 2 obtained by inducing edge shifts according to the recording method of the first modification. In FIG. 19, the case in which an edge shift of 1 T is induced by making a pit into a land is shown by way of example.

As shown in FIG. 19, when an edge shift of 1 T is induced by making a pit into a land, the recording waveform of type 1 (in the first bit write area with the polarity of NRZI bit stream 1 and in the second bit write area with the polarity of NRZI bit stream 2) has the edge shift position at the seventh channel bit from the beginning of the bit write area, in contrast to the case in which a land is made into a pit. The recording waveform of type 2 (in the first bit write area with the polarity of NRZI bit stream 2 and in the second bit write area with the polarity of NRZI bit stream 1) has the edge shift position at the eighth channel bit from the beginning of the bit write area, in contrast to the case in which a land is made into a pit.

Modulation bits in type 1 and type 2 subsequent to the edge shift have, as is clear from the comparison of FIG. 18 with FIG. 19, values that are opposite to those shown in FIG. 18. In other words, modulation bits in type 1 have a value of “001000100000100101”, which can be RLL-(1,7)-PP-demodulated into data bits shown at the bottom with a value of 847 (100001000111).

Modulation bits in type 2 have a value of “001000001000100101”, which can be RLL-(1,7)-PP-demodulated into data bits shown at the bottom with a value of B87 (101110000111).

Accordingly, even with the data value B47 stored by the recording method of the first modification, in association with the case in which an edge shift of 1 T is induced by making a pit into a land, modulation bits subsequent to the edge shift having a value that follows the RLL (1,7) PP modulation rule can be obtained.

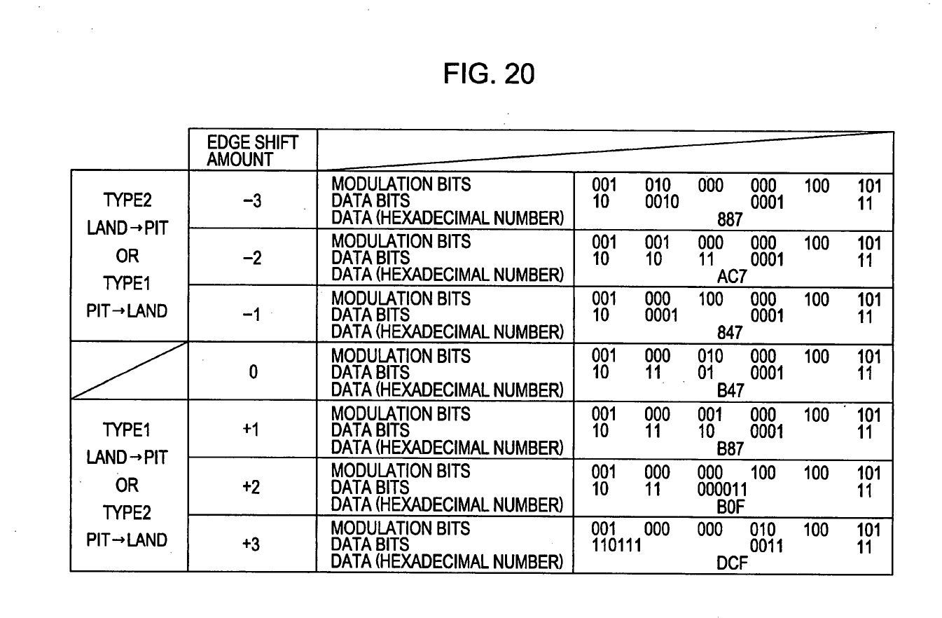

For the sake of reference, FIG. 20 shows all possible modes of edge shifts in the case of the data value B47 stored in each bit write area according to the first modification.

In FIG. 20, as in FIG. 7, all possible modes of edge shifts are indicated by amounts of positive and negative edge shifts. That is, when the amount of edge shift is “+”, it means that the position of the edge-to-be-shifted portion sft is shifted in the positive direction. The “+” edge shift amounts correspond to the case in which a land is made into a pit in the case of type 1 (case of type 1 in FIG. 18) and the case in which a pit is made into a land in the case of type 2 (case of type 2 in FIG. 19).

In contrast, when the amount of edge shift is “−”, it means that the position of the edge-to-be-shifted portion sft is shifted in the negative direction. The “−” edge shift amounts correspond to the case in which a land is made into a pit in the case of type 2 (case of type 2 in FIG. 18) and the case in which a pit is made into a land in the case of type 1 (case of type 1 in FIG. 19).

As can be understood with reference to FIG. 20, according to B43 in this case, edge shifts of up to 3 T can be handled both in the cases in which a land is made into a pit and a pit is made into a land.

Specifically, in the case in which a land is made into a pit and the recording waveform is of type 1, as the amount of edge shift increases in the order of +1 T, +2 T, and +3 T, modulation bits subsequent to the edge shift have values of “001000001000100101”, “001000000100100101”, and “001000000010100101”, which can be RLL-(1,7)-PP-demodulated into the data bit values B87 (101110000111), B0F (101100001111), and DCF (110111001111), respectively. In the case in which the recording waveform is of type 2, as the amount of edge shift increases in the order of −1 T, −2 T, and −3 T, modulation bits subsequent to the edge shift have values of “001000100000100101”, “001001000000100101”, and “001010000000100101”, which can be RLL-(1,7)-PP-demodulated into the data bit values 847 (100001000111), AC7 (101011000111), and 887 (100010000111), respectively.

Accordingly, in the case in which a land is made into a pit, modulation bits following the modulation rule within the range of shift amounts from 1 T to 3 T can be obtained in both cases of the recording waveforms of type 1 and of type 2. That is, the range from 1 T to 3 T can be handled.

In the case in which a pit is made into a land and the recording waveform is of type 1, as the amount of edge shift increases in the order of −1 T, −2 T, and −3 T, modulation bits subsequent to the edge shift have the same values as those in the above-described case in which a land is made into a pit and the recording waveform is of type 2. Accordingly, edge shifts of up to 3 T can be handled also in this case.

In the case in which a pit is made into a land and the recording waveform is of type 2, as the amount of edge shift increases in the order of +1 T, +2 T, and +3 T, modulation bits subsequent to the edge shift have the same values as those in the above-described case in which a land is made into a pit and the recording waveform is of type 1. Accordingly, edge shifts of up to 3 T can be handled also in this case.

Therefore, even when pits are made into lands, edge shifts of 1 T to 3 T can be handled.

Even with the recording method of the first modification, the aggregate jitter JA can be similarly obtained using the evaluation apparatus 1 performing the similar operation as described above.

Specifically, the edge shift amounts are measured in each first bit write area and each second bit write area, and the measured edge shift amounts in each type of bit write area are categorized with respect to their associated shift directions into positive-direction shifts and negative-direction shifts. On the basis of the categorized groups of the measured values (ΔTbit11−1−n, ΔTbit12−1−n, ΔTbit21−1−n, and ΔTbit22−1−n), the averages thereof (ΔTbit11, ΔTbit12, ΔTbit21, and ΔTbit22) and the standard deviations thereof (σ₁₁, σ₁₂, σ₂₁, and σ₂₂) are calculated.

Then, the jitter components J₁₁, J₁₂, J₂₁, and J₂₂ are calculated using equations (1), and the aggregate jitter JA is calculated using equation (2).

Accordingly, an evaluation index for accurately evaluating the recording quality of secondary data recorded by inducing edge shifts can be obtained.

Also in this case, the jitter components J (J₁₁, J₁₂, J₂₁, and J₂₂) are independently calculated for the distributions of edge shift amounts categorized with respect to their associated edge shift direction and bit write areas, and then the aggregate jitter JA is calculated by taking an average of the absolute values of these jitter components J. Even when the distribution characteristics of edge shift amounts are different depending on the edge shift direction and the type of bit write area, the more accurate aggregate jitter JA can be obtained.

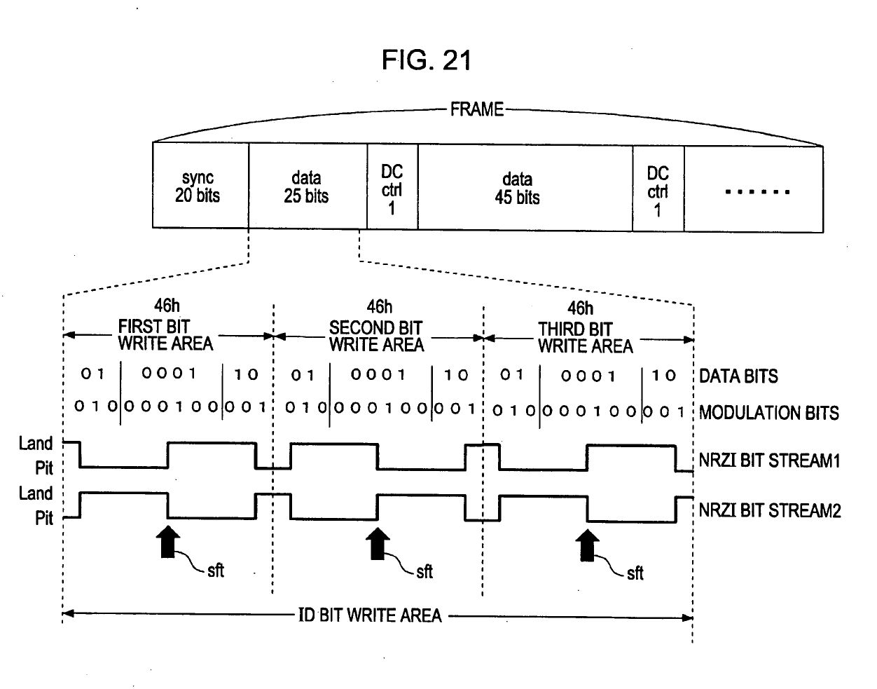

FIG. 21 shows a recording method according to a second modification.

In the recording method of the second modification, an ID bit write area with a total of 24 data bits has, as shown in FIG. 21, three bit write areas including first to third bit write areas.

Also in this case, a data value of a predetermined pattern, which is determined so that modulation bits thereof subsequent to the edge shift have a value that follows the RLL (1,7) PP modulation rule, is stored in each of the first to third bit write areas. Since the 24-bit area is divided into three areas, the predetermined pattern has an 8-bit value. Specifically, as shown in FIG. 21, 46 h (01000110) is stored.

With the data value 46h, modulation bits have a value of “010000100001”, which is shown in FIG. 21. As is indicated by NRZI bit stream 1 and NRZI bit stream 2, an edge portion between a land and a pit of a predetermined length (5 T) is formed, and this edge portion serves as the edge-to-be-shifted portion sft.

As in the above-described first modification, even in the case of the same NRZI bit stream, there are bit write areas having different recording waveforms. In this case, although the recording waveforms in the first bit write area and the third bit write area have the same polarity, only the recording waveform in the second bit write has a different polarity.

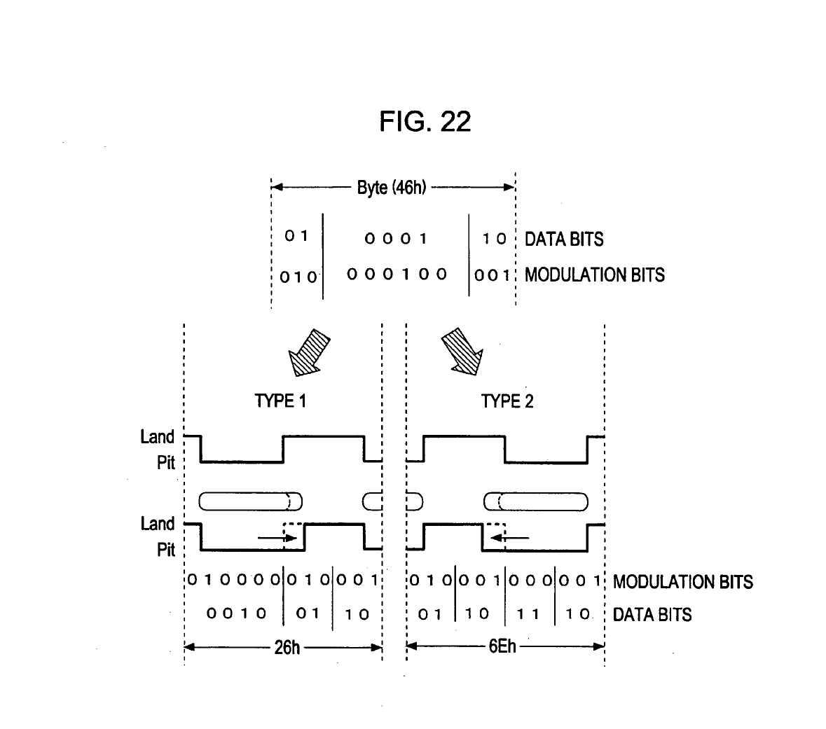

FIG. 22 shows the recording waveforms of type 1 and type 2 obtained by inducing edge shifts according to the recording method of the second modification. In FIG. 22, the case in which an edge shift of 1 T is induced by making a land into a pit is shown by way of example.

In this case, the only possible recording waveforms are of type 1 and type 2 shown in FIG. 22. Type 1 shows, as can be understood with reference to FIG. 21, the recording waveforms in the first bit write area and the third bit write area with the polarity of NRZI bit stream 1 and the recording waveform in the second bit write area with the polarity of NRZI bit stream 2. Type 2 shows the recording waveforms in the first bit write area and the third bit write area with the polarity of NRZI bit stream 2 and the recording waveform in the second bit write area with the polarity of NRZI bit stream 1.

As shown in FIG. 22, in the case in which an edge shift of 1 T is induced by making a land into a pit and the recording waveform is of type 1, the edge shift position is the seventh channel bit from the beginning from the bit write area. In contrast, when the recording waveform is of type 2, the edge shift position is the sixth channel bit from the beginning of the bit write area.

In the case of the recording waveform of type 1, when an edge shift of 1 T is induced by making a land into a pit, modulation bits have a value of “010000010001”, which can be RLL-(1,7)-PP-demodulated into data bits shown at the bottom with a value of 26 h (00100110).

In the case of the recording waveform of type 2, when an edge shift of 1 T is induced by making a land into a pit, modulation bits have a value of “010001000001”, which can be RLL-(1,7)-PP-demodulated into data bits shown at the bottom with a value of 6 Eh (01101110).

Accordingly, even with the recording method of the second modification, in association with the case in which an edge shift of 1 T is induced by making a land into a pit, modulation bits subsequent to the edge shift having a value that follows the RLL (1,7) PP modulation rule can be obtained.

Although not shown in FIG. 22, in the case of an edge shift of 2T induced by similarly making a land into a pit, modulation bits have a value of “010000001001” in type 1, which can be RLL-(1,7)-PP-demodulated into 2 Ah (00101010), and modulation bits have a value of “010010000001” in type 2, which can be RLL-(1,7)-PP-demodulated into 4 Ah (01001010).

As is clear from the description of FIGS. 7 and 20, in the case of an edge shift induced by making a land into a pit and the case of an edge shift induced by making a pit into a land, modulation bits subsequent to the edge shift have the same value, except that the opposite values are obtained depending on whether the recording waveform of type 1 or the recording waveform of type 2 is shifted. In other words, the fact that a value that follows the modulation rule can be obtained even with an edge shift of 2 T induced by making a land into a pit means that, when a pit is made into a land, it is also possible to similarly obtain modulation bits subsequent to an edge shift of 2 T having a value that follows the modulation rule.

With the data value 46 h according to the second modification, edge shifts of up to 2 T can be handled both in the cases in which a land is made into a pit and a pit is made into a land.

In the second modification, the formatting is done in the above-described formatting step S11 shown in FIG. 16 to achieve the data structure in the frame shown in FIG. 21.

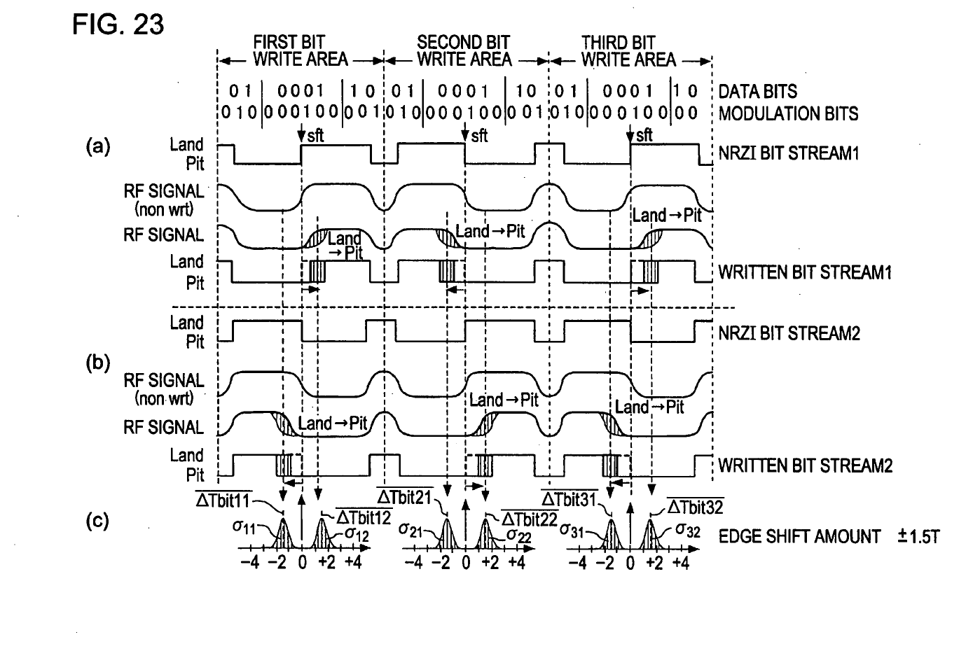

FIG. 23 schematically shows fluctuation in shift amounts in each type of edge-shifted portion in the case where the recording method according to the second modification is employed.

FIG. 23 shows, as in FIG. 11, a value of data bits (46 h) stored in each of the first to third bit write areas in the ID bit write area in each frame and a value of modulation bits obtained subsequent to RLL (1,7) PP modulation. In FIG. 23, the case in which an edge shift of 1.5 T is induced is shown by way of example.

Referring to FIG. 23, portion (a) shows the recording waveform and the RF signal waveform (non wrt) of NRZI bit stream 1 obtained in accordance with the stored value 46 h and therebelow shows the RF signal waveform and the recording waveform (written bit stream 1) obtained by inducing edge shifts.

Portion (b) of FIG. 23 shows the recording waveform and the RF signal waveform (non wrt) of NRZI bit stream 2 obtained in accordance with the stored value 46 h and therebelow shows the RF signal waveform and the recording waveform (written bit stream 2) obtained by inducing edge shifts.

Each of the waveforms shown in portions (a) and (b) of FIG. 23, especially the RF signal waveforms and the recording waveforms (written bit streams) obtained by inducing edge shifts, is generated by placing waveforms obtained under the same condition in the ID bit write areas in frames on the disk 100 on top of one another. Specifically, each of the waveforms in each bit write area shown in portion (a) of FIG. 23 is generated by placing all the waveforms in each type of bit write area with the polarity of NRZI bit stream 1 on top of one another. Similarly, each of the waveforms in each type of bit write area shown in portion (b) of FIG. 23 is generated by placing all the waveforms in each bit write area with the polarity of NRZI bit stream 2 on top of one another.

Portion (c) of FIG. 23 shows the distributions of edge shift amounts with respect to six conditions: the first, second, and third bit write areas, and the polarities of NRZI in each bit write area.

As can be understood with reference to FIG. 23, even when the recording method of the second modification is employed, the edge shift direction in each bit write area is different depending on the polarity of NRZI.

In the second modification, each ID bit write area is divided into three bit write areas. Because the shift direction is different due to the different NRZI polarity, as has been described above, each bit write area has two distributions, resulting in a total of six distributions of edge shift amounts, as shown in portion (c) of FIG. 23.

When the edge shift direction is different, so are the distribution characteristics. It is thus necessary to handle the measured values of the edge shift amounts with respect to the edge shift directions, especially when calculating an accurate jitter.

Since the distribution characteristics of edge shift amounts may be different in each bit write area, it is preferable that the measured values of the edge shift amounts be handled separately in each type of bit write area.

The evaluation apparatus 1 of the second modification measures the edge shift amounts separately in each type of bit write area. In addition, the measured values of the edge shift amounts in each type of bit write area are categorized into whether they are positive or negative edge shifts. Then, the average and the standard deviation of each categorized group of the measured values are calculated.

As shown in portion (c) of FIG. 23, the average ΔTbit11 and the standard deviation Ω₁₁ are calculated on the basis of the measured values of edge shifts determined to be in the negative direction in the first bit write areas. The average ΔTbit12 and the standard deviation Ω₁₂ are calculated on the basis of the measured values of edge shifts determined to be in the positive direction in the first bit write areas.

Similarly, the averages ΔTbit21 and ΔTbit22 and the standard deviations Ω₂₁ and Ω₂₂ are calculated on the basis of the measured values of edge shifts in the negative and positive directions in the second bit write areas, respectively. Further, the averages ΔTbit31 and ΔTbit32 and the standard deviations Ω₃₁ and Ω₃₂ are calculated on the basis of the measured values of edge shifts in the negative and positive directions in the third bit write areas, respectively.

Also in this case, the measured values in each type of bit write area are categorized by the evaluation apparatus 1 on the basis of the setting of the threshold th1 and the threshold th2.

In the second modification, the position of the edge-to-be-shifted portion sft from frame sync is different from that described in the above-described embodiment. By detecting the edge position of a binary signal within an effective interval with a range in accordance with the edge-to-be-shifted portion sft at a different position, the edge position of the edge-to-be-shifted portion sft subsequent to the edge shift can be accurately detected.

In this case, the averages (ΔTbit11, ΔTbit12, ΔTbit21, ΔTbit22, ΔTbit31, and ΔTbit32) and the standard deviations (Ω₁₁, Ω₁₂, Ω₂₁, Ω₂₂, Ω₃₁, and Ω₃₂) of a total of six distributions of edge shift amounts are calculated, and then six jitter components J₁₁, J₁₂, J₂₁, J₂₂, J₃₁, and J₃₂ on the basis of the corresponding distributions are calculated using the following equations (3):

$$\begin{matrix}{J}_{11} = \frac{{σ}_{11}}{2 \times ( \overline{Δ Tbit 11} - 0.5 T )} & {J}_{12} = \frac{{σ}_{12}}{2 \times ( \overline{Δ Tbit 12} - 0.5 T )} \\ {J}_{21} = \frac{{σ}_{21}}{2 \times ( \overline{Δ Tbit 21} - 0.5 T )} & {J}_{22} = \frac{{σ}_{22}}{2 \times ( \overline{Δ Tbit 22} - 0.5 T )} \\ {J}_{31} = \frac{{σ}_{31}}{2 \times ( \overline{Δ Tbit 31} - 0.5 T )} & {J}_{32} = \frac{{σ}_{32}}{2 \times ( \overline{Δ Tbit 32} - 0.5 T )}\end{matrix} \qquad ( 3 )$$

Then, on the basis of the six jitter components J₁₁, J₁₂, J₂₁, J₂₂, J₃₁, and J₃₂, the aggregate jitter JA is calculated using the following equation (4):

$$JA = \sqrt{\frac{{J}_{11}^{2} + {J}_{12}^{2} + {J}_{21}^{2} + {J}_{22}^{2} + {J}_{31}^{2} + {J}_{32}^{2}}{6}} \qquad ( 4 )$$

Also in this case, since each jitter component J is obtained using the corresponding equation (3) on the basis of the average and the standard deviation of each distribution and the minimum shift amount, it is possible to obtain a jitter with respect to a range in which edge shifts are detectable. That is, the jitter components J suitable for evaluating the recording quality of secondary data recorded by inducing edge shifts can be obtained.

Therefore, as shown by equation (4), according to the aggregate jitter JA corresponding to the average of the jitter components J (the absolute values thereof), it is possible to obtain an evaluation index for accurately evaluating the recording quality of secondary data recorded by inducing edge shifts.

Also in this case, each jitter component J (J₁₁, J₁₂, J₂₁, J₂₂, J₃₁, and J₃₂) is obtained independently in each distribution of edge shift amounts categorized with respect to their associated edge shift directions and bit write areas, and then the aggregate jitter JA equivalent to the average of absolute values of these jitter components J is calculated. Accordingly, even when the characteristics of the distribution of the edge shift amounts are different depending on the edge shift direction and the type of bit write area, the more accurate aggregate jitter JA can be calculated.

Although the embodiment of the present invention has been described, the present invention is not limited thereto.

For example, in the embodiment, the case in which the evaluation apparatus 1 is associated with the disk 100 on which edge shifts are induced by making lands into pits has been described by way of example. However, when edge shifts are induced by making pits into lands, similar advantages can be achieved by similar operations. That is, due to the change to edge shifts being induced by making pits into lands, only the shift direction becomes opposite. The evaluation apparatus 1 performing similar operations can similarly measure the aggregate jitter JA.

In the embodiment, the fact that the distribution characteristics of edge shift amounts are different depending on the edge shift direction and the fact that the characteristics of the distribution of edge shift amounts are different depending on the type of bit write area are both taken into consideration, and the measured values are categorized with respect to their associated bit write areas and edge shift directions. For the distributions of the categorized groups of the measured values, the jitter components J are calculated, and the aggregate jitter JA is calculated on the basis of the jitter components J.

However, for example, only one of the two facts may be taken into consideration, and the measured values may be categorized with respect to their associated bit write areas or with respect to their associated edge shift directions. For the distributions of the categorized groups of the measured values, the jitter components J may be calculated, and the aggregate jitter JA may be calculated on the basis of the jitter components J.

In the embodiment, the measured values are categorized with respect to their associated shift directions on the basis of the threshold th1 and the threshold th2. However, many other methods are also conceivable.

For example, when the data value to be stored is B43, in the case of edge shifts induced by making lands into pits, as can be understood with reference to FIG. 11, the edge shifts in the case of the polarity of NRZI bit stream 1 are in the positive direction both in the first bit write area and the second bit write area. In the case of the polarity of NRZI bit stream 2, the edge shifts are in the negative direction both in the first bit write area and the second bit write area. Now, polarity information in each frame may be input to the evaluation apparatus 1. At the time of measuring the edge shift amounts, the measured values may be categorized on the basis of the polarity information in each frame.

In this way, the measured values can be more reliably categorized with respect to the positive and negative shift directions. Also in this case, the measured values corresponding to no edge shift may be similarly excluded on the basis of the threshold th1 and the threshold th2.

When pits are made into lands, only the polarity and the shift direction are opposite to those when lands are made into pits. By categorizing the measured values in a manner opposite to the above, the measured values can be accurately categorized with respect to the positive and negative directions.

In the future, secondary data may be additionally recorded on one disk 100 by inducing edge shifts both by making lands into pits and by making pits into lands.

When secondary data is additionally recorded in this manner, it is expected that a portion in which an edge shift is induced by making a land into a pit and a portion in which an edge shift is induced by making a pit into a land have different distribution characteritiscs of edge shift amounts. Therefore, there may be a demand for separate sampling of the shift amounts in edge-shifted portions in which edge shifts are induced by making lands into pits and in edge-shifted portions in which edge shifts are induced by making pits into lands, thereby individually calculating the jitter components J.

It is difficult, however, to distinguish between the edge-shifted portions in which edge shifts are induced by making lands into pits and the edge-shifted portions in which edge shifts are induced by making pits into lands using the method based on the threshold th11 and the threshold th2, which has been described in the embodiment.

To distinguish between the two types of edge-shifted portions, a categorizing method based on the above-described polarity information in each frame is effective.

For example, with reference to FIGS. 5 and 6, the case of storing B43 will be examined. The edge shift position subsequent to a shift is different when a land is made into a pit and when a pit is made into a land. In other words, in the case of making a land into a pit in FIG. 5, the edge shift position in the case of type 1 (i.e., the polarity of NRZI bit stream 1) is the eighth clock (7+1 T shift) from the beginning, and the edge shift position in the case of type 2 (polarity of NRZI bit stream 2) is the sixth clock (7−1 T shift) from the beginning. In contrast, in the case of making a pit into a land in FIG. 6, the edge shift position in type 1 is the sixth clock from the beginning, and the edge shift position in type 2 is eighth clock from the beginning.

Information on the edge position determined by the polarity of a frame in the two cases in which a land is made into a pit and a pit is made into a land is set in advance in the evaluation apparatus 1. In addition, polarity information in each frame is given to the evaluation apparatus 1 so that the polarity of a frame in which the edge shift amounts are measured can be detected.

Accordingly, on the basis of the given polarity information in each frame, the evaluation apparatus 1 can detect the polarity information in a frame in which the measurement is performed. On the basis of the polarity information, the evaluation apparatus 1 can obtain the edge position information in that frame in the two cases in which a land is made into a pit and a pit is made into a land. After that, by determining the edge position to which the measured edge position corresponds, the evaluation apparatus 1 can determine whether the detected value is obtained by making a land into a pit or by making a pit into a land. On the basis of this information, the measured edge shift amounts are categorized, thereby categorizing the measured values into lands being made into pits and pits being made into lands.

In this case, while detecting the edge positions in each type of bit write area and measuring the corresponding shift amounts, the evaluation apparatus 1 categorizes the measured values in each type of bit write area into groups of lands being made into pits and pits being made into lands, and further categorizes the measured values with respect to the positive and negative shift directions. Then, the jitter components J are calculated for the categorized groups of sampled data, and the average of the absolute values of the jitter components J is calculated as the aggregate jitter JA.

In this manner, the appropriate aggregate jitter JA taking into consideration the fact that the distribution characteristics are different depending on the positive/negative shift directions and on whether edge shifts are induced by making lands into pits or by making pits into lands can be calculated.

In categorizing into lands being made into pits and pits being made into lands, as in the first and second modifications, when the recording waveforms in the same frame have different polarities depending on the type of bit write area, as in the case of B43, it is difficult to determine whether an edge shift is induced by making a land into a pit or by making a pit into a land only on the basis of the polarity information in each frame and information on the edge shift position subsequent to the shift according to each polarity.

In other words, it is also necessary in this case to have information on the position of an edge shift induced by making a land into a pit and of the position of an edge shift induced by making a pit into a land in each type of bit write area.

More specifically, in this case, in addition to the NRZI polarity information in each frame necessary for detecting the polarity of a frame in which the measurement is performed, it is also necessary that the evaluation apparatus 1 be given information on the edge positions of shifts induced by making a land into a pit and by making a pit into a land in each bit write area when the polarity of the frame corresponds to NRZI bit stream 1 and information on the edge positions of shifts induced by making a land into a pit and by making a pit into a land in each bit write area when the polarity of the frame corresponds to NRZI bit stream 2.

This enables the evaluation apparatus 1 to detect, at the time of measurement, the polarity of the frame on the basis of the given NRZI polarity information in each frame. Since the evaluation apparatus 1 can detect the polarity of the frame, the evaluation apparatus 1 can also detect the positions of shifts induced by making a land into a pit and by making a pit into a land in each bit write area in that frame.

In each bit write area, it is determined to which of the edge positions induced by making a land into a pit and by making a pit into a land, which are recognized in this manner, the detected edge position corresponds, thereby determining whether the edge shift in that bit write area is induced by making a land into a pit or by making a pit into a land. That is, the measured edge shift amounts are categorized on the basis of the determination information, thereby categorizing the measured values into lands being made into pits and pits being made into lands.

In the embodiment, the case in which the evaluation apparatus according to the embodiment of the present invention is included in the configuration for playing back an optical recording medium has been described by way of example. However, the secondary data jitter measuring circuit 20 shown in FIG. 13 may be external to the playback apparatus for the optical disk recording medium. In this case, it is necessary for the evaluation apparatus to at least include the secondary data jitter measuring circuit 20.

It should be understood by those skilled in the art that various modifications, combinations, sub-combinations, and alterations may occur depending on design requirements and other factors insofar as they are within the scope of the appended claims or the equivalents thereof.

What is claimed is:

1. An evaluation apparatus for evaluating the recording quality of secondary data recorded on an optical disk recording medium on which primary data different from the secondary data is recorded as combinations of pits and lands, the secondary data being recorded by inducing edge shifts by irradiating edge portions between pits and lands formed at a plurality of positions with a laser beam of predetermined recording power, the evaluation apparatus comprising:
reading means for reading a signal on the basis of reflected light information of a laser beam of playback power irradiated onto the optical disk recording medium;
binarizing means for slicing the signal read by the reading means at a predetermined level and outputting the result as a binary signal; and
jitter calculating means for calculating a jitter of edge shift amounts in portions, among the edge portions between the pits and the lands formed at the plurality of positions, in which the edge shifts are induced, the edge shift amounts being measured on the basis of the binary signal obtained by the binarizing means, the jitter being calculated on the basis of a standard deviation and an average of the edge shift amounts and information on a predetermined minimum shift amount determined as the minimum amount of shift that can be detected by a binary decision as an edge shift.

2. The evaluation apparatus according to claim 1, wherein the jitter calculating means calculates the jitter by dividing the standard deviation by twice the difference obtained by subtracting the minimum shift amount from the average.

3. The evaluation apparatus according to claim 1, wherein
the primary data is recorded subsequent to being subjected to RLL (1,7) PP modulation and NRZI modulation, and
the jitter calculating means categorizes the measured edge shift amounts with respect to the associated edge shift directions and calculates the jitter on the basis of each categorized group of the edge shift amounts.

4. The evaluation apparatus according to claim 1, wherein
the primary data is recorded subsequent to being subjected to RLL (1,7) PP modulation and NRZI modulation,
each frame of a predetermined length in the primary data includes a secondary data write area having a predetermined number of successive bit write areas, the bit write areas each including an edge portion between a pit and a land serving as an edge-to-be-shifted portion and storing predetermined identical pattern data so that the primary data subsequent to the shift follows the RLL (1,7) PP modulation rule, and
the jitter calculating means categorizes the measured edge shift amounts with respect to the associated types of bit write areas in the frames and calculates the jitter on the basis of each categorized group of the edge shift amounts.

5. The evaluation apparatus according to claim 1, wherein
the primary data is recorded subsequent to being subjected to RLL (1,7) PP modulation and NRZI modulation,
each frame of a predetermined length in the primary data includes a secondary data write area having a predetermined number of successive bit write areas, the bit write areas each including an edge portion between a pit and a land serving as an edge-to-be-shifted portion and storing predetermined identical pattern data so that the primary data subsequent to the shift follows the RLL (1,7) PP modulation rule,
the jitter calculating means categorizes the measured edge shift amounts with respect to the associated types of bit write areas in the frames, further categorizes the edge shift amounts with respect to the associated edge shift directions, and calculates the jitter on the basis of each categorized group of the edge shift amounts, and
the jitter calculating means calculates an aggregate jitter by taking an average of the absolute values of the jitters.

6. An evaluation apparatus for evaluating the recording quality of secondary data recorded on an optical disk recording medium on which primary data different from the secondary data is recorded as combinations of pits and lands, the secondary data being recorded by inducing edge shifts by irradiating edge portions between pits and lands formed at a plurality of positions with a laser beam of predetermined recording power, the evaluation apparatus comprising:
jitter calculating means for calculating a jitter of edge shift amounts in portions, among the edge portions between the pits and the lands formed at the plurality of positions, in which the edge shifts are induced, the edge shift amounts being measured on the basis of a binary signal obtained by playing back the optical disk recording medium, the jitter being calculated on the basis of a standard deviation and an average of the edge shift amounts and information on a predetermined minimum shift amount determined as the minimum amount of shift that can be detected by a binary decision as an edge shift.

7. An evaluation method for evaluating the recording quality of secondary data recorded on an optical disk recording medium on which primary data different from the secondary data is recorded as combinations of pits and lands, the secondary data being recorded by inducing edge shifts by irradiating edge portions between pits and lands formed at a plurality of positions with a laser beam of predetermined recording power, the evaluation method comprising the step of:
calculating a jitter of edge shift amounts measured in portions, among the edge portions between the pits and the lands formed at the plurality of positions, in which the edge shifts are induced, the jitter being calculated on the basis of a standard deviation and an average of the edge shift amounts and information on a predetermined minimum shift amount determined as the minimum amount of shift that can be detected by a binary decision as an edge shift.

8. An optical disk manufacturing method for manufacturing an optical disk recording medium on which primary data is recorded as combinations of pits and lands and on which secondary data different from the primary data is recorded by inducing edge shifts by irradiating edge portions between pits and lands formed at a plurality of positions with a laser beam of predetermined recording power, the optical disk manufacturing method comprising the steps of:
producing a master disk on which the primary data is recorded and on which the edge portions between the pits and the lands are formed at the plurality of positions;
generating a disk substrate using a stamper fabricated on the basis of the master disk and laminating at least a reflecting layer and a covering layer on the disk substrate to produce a primary data recording disk on which the primary data is recorded;
recording, with a recording apparatus, the secondary data different from the primary data by inducing the edge shifts by irradiating the edge portions between the pits and the lands formed at the plurality of positions on the primary data recording disk with the laser beam of the predetermined recording power;
calculating a jitter of edge shift amounts measured in portions, among the edge portions between the pits and the lands formed at the plurality of positions on the optical disk recording medium on which the secondary data is recorded, in which the edge shifts are induced, the jitter being calculated on the basis of a standard deviation and an average of the edge shift amounts and information on a predetermined minimum shift amount determined as the minimum amount of shift that can be detected by a binary decision as an edge shift;
adjusting a parameter of the recording apparatus for recording the secondary data on the basis of the calculated jitter; and
recording the secondary data on the primary data recording disk with the recording apparatus for which the parameter is adjusted.

9. An evaluation apparatus for evaluating the recording quality of secondary data recorded on an optical disk recording medium on which primary data different from the secondary data is recorded as combinations of pits and lands, the secondary data being recorded by inducing edge shifts by irradiating edge portions between pits and lands formed at a plurality of positions with a laser beam of predetermined recording power, the evaluation apparatus comprising:
a reading unit operable to read a signal on the basis of reflected light information of a laser beam of playback power irradiated onto the optical disk recording medium;
a binarizing unit operable to slice the signal read by the reading unit at a predetermined level and output the result as a binary signal; and
a jitter calculating unit operable to calculate a jitter of edge shift amounts in portions, among the edge portions between the pits and the lands formed at the plurality of positions, in which the edge shifts are induced, the edge shift amounts being measured on the basis of the binary signal obtained by the binarizing unit, the jitter being calculated on the basis of a standard deviation and an average of the edge shift amounts and information on a predetermined minimum shift amount determined as the minimum amount of shift that can be detected by a binary decision as an edge shift.

10. An evaluation apparatus for evaluating the recording quality of secondary data recorded on an optical disk recording medium on which primary data different from the secondary data is recorded as combinations of pits and lands, the secondary data being recorded by inducing edge shifts by irradiating edge portions between pits and lands formed at a plurality of positions with a laser beam of predetermined recording power, the evaluation apparatus comprising:
a jitter calculating unit operable to calculate a jitter of edge shift amounts in portions, among the edge portions between the pits and the lands formed at the plurality of positions, in which the edge shifts are induced, the edge shift amounts being measured on the basis of a binary signal obtained by playing back the optical disk recording medium, the jitter being calculated on the basis of a standard deviation and an average of the edge shift amounts and information on a predetermined minimum shift amount determined as the minimum amount of shift that can be detected by a binary decision as an edge shift.
